(19) United States
(12) Patent Application Publication
(10) Pub. No.: US 2026/0219915 A1
(43) Pub. Date: Jul. 30, 2026

(54) INFORMATION PROCESSING SYSTEM, INFORMATION PROCESSING METHOD, AND STORAGE MEDIUM

(71) Applicant: NEC Corporation, Tokyo (JP)

(72) Inventor: Mineto SATOH, Tokyo (JP)

(73) Assignee: NEC Corporation, Tokyo (JP)

(21) Appl. No.: 19/145,980

(22) PCT Filed: Mar. 29, 2023
(86) PCT No.: PCT/JP2023/012924

§ 371 Date: Jul. 7, 2025

(51) Int. Cl. G06F 9/455

(52) U.S. Cl. CPC G06F 9/45558; G06F 2009/45587

(57) ABSTRACT

An information processing system of the present disclosure includes: a virtualizing unit that sets virtual target information representing a control target having a movable part in a virtual environment based on state information representing a movable situation of the control target, and sets no-entry region information representing a no-entry region of the control target based on observation information obtained by observing a movable space of the control target; a model generating unit that generates a model that identifies a determined part that is a part on which it is determined whether to enter the no-entry region of the control target, using the virtual target information and the no-entry region information; and a determining unit that identifies the determined part of the control target from second state information of the control target using the model, and determines whether the determined part enters the no-entry region based on the second observation information.

### TECHNICAL FIELD

The present disclosure relates to an information processing system, an information processing method, and a storage medium.

### BACKGROUND ART

Various robots such as an arm-equipped robot, an autonomous transport vehicle and a construction machine are being introduced in a manufacturing site, a construction site and the like, and there are various control technologies for controlling these robots. For example, Patent Literature 1 describes identifying a target object from an image captured by a robot arm, predicting the trajectory of the robot arm, and executing an evasive motion of the robot arm when there is a possibility of collision between the robot arm and the target object.

### CITATION LIST

### Patent Literature

Patent Literature 1: Japanese Unexamined Patent Application Publication JP 2022-077228A

### SUMMARY OF INVENTION

### Technical Problem

However, with the technique described in the aforementioned Patent Literature 1, the possibility of collision with a target object is predicted using a captured image obtained by capturing an actual robot, which leads to a problem that the possibility of collision to be predicted becomes dependent on an imaging condition at the site. As a result, there arises a problem that the operation of a control target such as a robot cannot be controlled with higher accuracy.

Accordingly, an object of the present disclosure is to provide an information processing system that can solve the aforementioned problem of being unable to control the operation of a control target with higher accuracy.

### Solution to Problem

An information processing system as an aspect of the present disclosure includes: a virtualizing unit configured to set virtual target information representing a control target having a movable part in a virtual environment based on state information representing a movable situation of the control target, and set no-entry region information representing a no-entry region of the control target based on observation information obtained by observing a movable space of the control target; a model generating unit configured to generate a model that identifies a determined part using the virtual target information and the no-entry region information, the determined part being a part on which it is determined whether to enter the no-entry region of the control target; and a determining unit configured to identify the determined part of the control target from second state information of the control target using the model, and determine whether the determined part enters the no-entry region based on the second observation information.

Further, an information processing system as an aspect of the present disclosure includes: a virtualizing unit configured to set virtual target information representing a control target having a movable part in a virtual environment based on state information representing a movable situation of the control target, and set no-entry region information representing a no-entry region of the control target based on observation information obtained by observing a movable space of the control target; and a model generating unit configured to generate a model that identifies a determined part using the virtual target information and the no-entry region information, the determined part being a part on which it is determined whether to enter the no-entry region of the control target.

Further, an information processing method as an aspect of the present disclosure includes: setting virtual target information representing a control target having a movable part in a virtual environment based on state information representing a movable situation of the control target, and setting no-entry region information representing a no-entry region of the control target based on observation information obtained by observing a movable space of the control target; generating a model that identifies a determined part using the virtual target information and the no-entry region information, the determined part being a part on which it is determined whether to enter the no-entry region of the control target; and identifying the determined part of the control target from second state information of the control target using the model, and determining whether the determined part enters the no-entry region based on the second observation information.

Further, an information processing method as an aspect of the present disclosure includes: setting virtual target information representing a control target having a movable part in a virtual environment based on state information representing a movable situation of the control target, and setting no-entry region information representing a no-entry region of the control target based on observation information obtained by observing a movable space of the control target; and generating a model that identifies a determined part using the virtual target information and the no-entry region information, the determined part being a part on which it is determined whether to enter the no-entry region of the control target.

Further, a program as an aspect of the present disclosure includes instructions for causing a computer to execute processes to: set virtual target information representing a control target having a movable part in a virtual environment based on state information representing a movable situation of the control target, and set no-entry region information representing a no-entry region of the control target based on observation information obtained by observing a movable space of the control target; generate a model that identifies a determined part using the virtual target information and the no-entry region information, the determined part being a part on which it is determined whether to enter the no-entry region of the control target; and identify the determined part of the control target from second state information of the control target using the model, and determine whether the determined part enters the no-entry region based on the second observation information.

Further, a program as an aspect of the present disclosure includes instructions for causing a computer to execute processes to: set virtual target information representing a control target having a movable part in a virtual environment based on state information representing a movable situation of the control target, and set no-entry region information representing a no-entry region of the control target based on observation information obtained by observing a movable space of the control target; and generate a model that identifies a determined part using the virtual target information and the no-entry region information, the determined part being a part on which it is determined whether to enter the no-entry region of the control target.

### Advantageous Effects of Invention

With the configurations as described above, the present disclosure can control the operation of a control target with higher accuracy.

### BRIEF DESCRIPTION OF DRAWINGS

FIG. 1 is a block diagram showing an overall configuration of an information processing system in a first example embodiment of the present disclosure.

FIG. 2 is a block diagram showing a configuration of part of a determination model generation device disclosed in FIG. 1.

FIG. 3A is a flowchart showing the operation of the information processing system disclosed in FIG. 1.

FIG. 3B is a flowchart showing the operation of the information processing system disclosed in FIG. 1.

FIG. 4 is a diagram for describing an operation example of the information processing system disclosed in FIG. 1.

FIG. 5 is a block diagram showing an overall configuration of an information processing system in a second example embodiment of the present disclosure.

FIG. 6 is a diagram for describing an operation example of the information processing system disclosed in FIG. 5.

FIG. 7 is a diagram showing an example of a configuration of an application example 1 of an information processing system in a third example embodiment of the present disclosure.

FIG. 8 is a diagram showing an example of a configuration of an application example 2 of the information processing system in the third example embodiment of the present disclosure.

FIG. 9 is a block diagram showing a hardware configuration of an information processing system in a fourth example embodiment of the present disclosure.

FIG. 10 is a block diagram showing a configuration of the information processing system in the fourth example embodiment of the present disclosure.

### EXAMPLE EMBODIMENTS

### First Example Embodiment

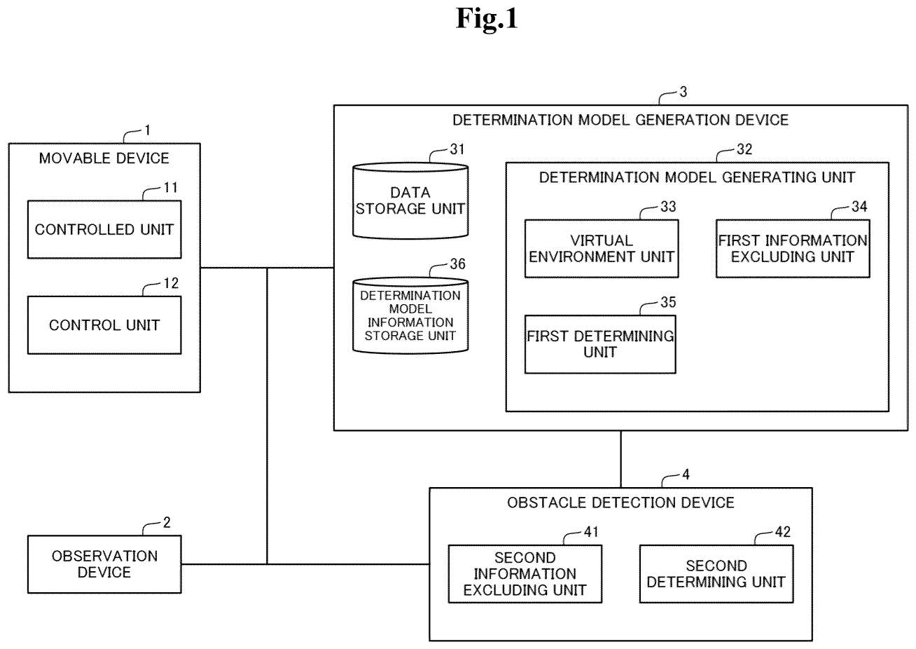

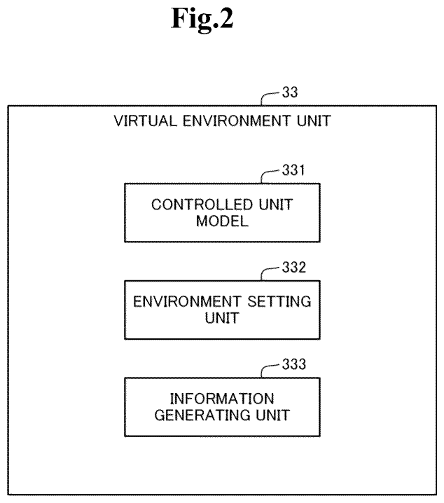

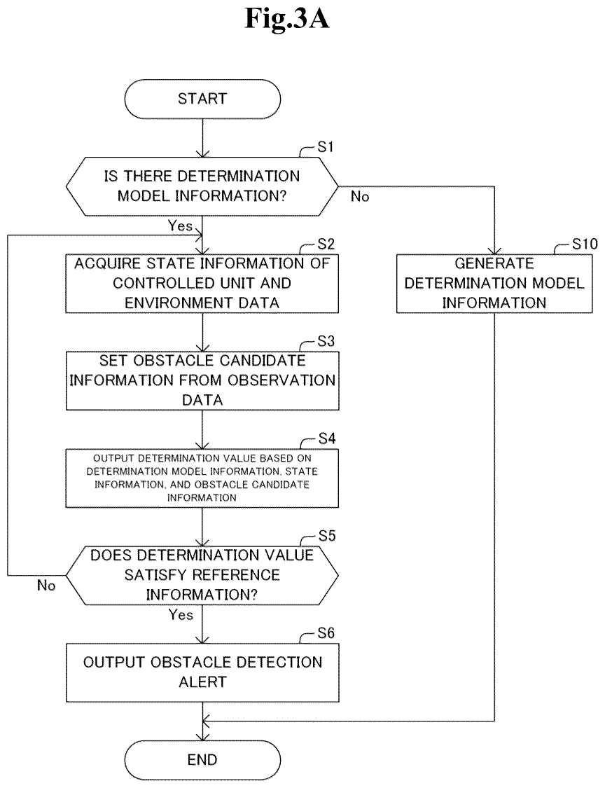

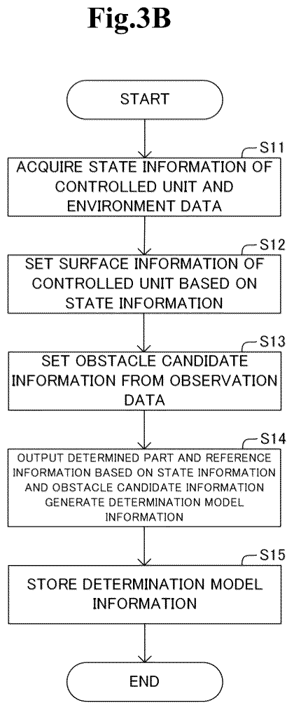

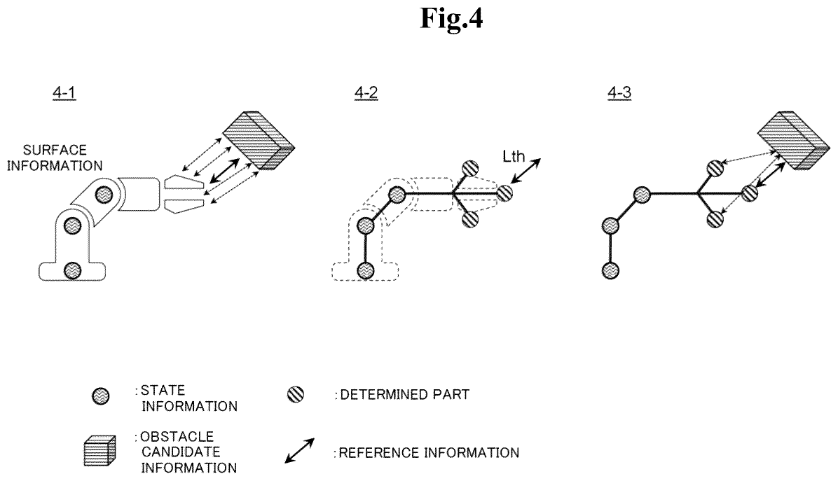

A first example embodiment of the present disclosure will be described with reference to FIGS. 1 to 4. FIGS. 1 to 2 are diagrams for describing a configuration of an information processing system, and FIGS. 3 to 4 are diagrams for describing processing operation of the information processing system.

### [Configuration]

The information processing system in this example embodiment controls, as a control target, a movable device such as a robot that can be introduced in a manufacturing site and a construction site. Then, the information processing system has a function to control the movable device with more accuracy, particularly, a function to enable the movable device to avoid collision with an obstacle.

FIG. 1 shows an example of an overall configuration of the information processing system according to the first example embodiment. As shown in FIG. 1, the information processing system includes a movable device 1, an observation device 2, a determination model generation device 3, and an obstacle detection device 4. The information processing system is a system that, in the movable device 1, has a control unit 12 to be described later and controls a controlled unit 11 based on information obtained from the observation device 2. Although this example embodiment illustrates a case where the information processing system is composed of four devices, it may be composed of any number of devices. For example, the determination model generation device 3 and the obstacle detection device 4 may be configured with one information processing device, or they may be configured distributedly across three or more information processing devices. In the following, firstly, the overview of the configurations of the respective devices 1 to 4 will be described.

The movable device 1 includes the controlled unit 11 that is a target to be controlled (an example of a control target), and the control unit 12 that controls the controlled unit 11 (an example of a control means). The control unit 12 is configured with an information processing device equipped with an arithmetic logic unit and a memory unit.

The movable device 1 is, for example, an arm-equipped robot, transport vehicle, construction machine (hereinafter referred to as construction machine) and the like, but is not limited to them. Examples of an arm-equipped construction machine include a power shovel, a backhoe, a crane, and a forklift. In a power shovel, a backhoe, a crane, and a forklift, a housing portion performing work, such as an arm, a bucket and a shovel, is the controlled unit 11. The control unit 12 controls the operation of the controlled unit 11. By the control of the controlled unit 11 by the control unit 12, the controlled unit 11 is enabled to move in a predetermined manner. The movable device 1 is not necessarily limited to having an arm, and may have any movable part other than an arm.

The observation device 2 acquires and outputs observation data (observation information), which is ranging information obtained by observing a space where at least the movable device 1 can move (movable space). Specifically, the observation device 2 can be an imaging sensor that captures the movable range of the controlled unit 11 as three-dimensional data, such as a device such as a camera that is a combination of a monocular, binocular, monochrome or RGB camera with a depth sensor (RGB-D camera) and a ToF (Time of Flight) camera, or a device that optically measures the distance to the target two-dimensionally or three-dimensionally in the horizontal and vertical directions to the distance direction, such as LiDAR (Light Detection And Ranging), or a device that measures using radio waves, such as Radar (Radio Detection and Ranging), and the specific configurations of these devices are not limited in this embodiment.

The observation device 2 may be a single device described above, or may be a combination of a plurality of devices. Moreover, a region that the observation device 2 observes may include the controlled unit 11. In that case, the observation data obtained by the observation device 2 includes part of the housing of the controlled unit 11. Therefore, the observation data may include information on the surrounding environment such as an obstacle and information on the controlled unit 11 of the movable device 1 that is the control target. Here, the observation region of the observation device 2 is determined by conditions such as the installation position and installation direction (angle) when the observation device 2 is installed and the inherent performance and parameters of the observation device. The installation of the observation device 2 can be appropriately determined based on the type and performance of the observation device 2, the specifications of the movable device 1 as the observation target (e.g., type, size, movable range, etc.) and the content of work thereof, and the surrounding environment, and is not limited in the present invention. The types of the observation device 2 are distinguished by difference in measurement method, and examples of the type include a camera, a video camera, LiDAR, radar and so forth. Examples of the performance of the observation device 2 include fields of view (FOV), maximum measurement distance, resolution, and so forth. The observation device 2 may be mounted on the movable device 1. The format of the observation data is not limited, but it can be three-dimensional information of a space where at least the movable device 1 operates, such as the combination of RGB pixel data with depth or distance information, or point cloud data as an example of the set information of three-dimensional positions.

The determination model generation device 3 is configured with one or a plurality of information processing devices each including an arithmetic logic unit and a memory unit. Then, as shown in FIG. 1, the determination model generation device 3 includes a data storage unit 31 and a determination model information storage unit 36. The data storage unit 31 and the determination model information storage unit 36 are configured with the memory unit. Moreover, the determination model generation device 3 includes a determination model generating unit 32. The function of the determination model generating unit 32 can be enabled by execution of a program for enabling the function stored in the storage unit by the arithmetic unit.

The data storage unit 31 stores state information on the controlled unit 11 and observation data acquired by the observation device 2. The determination model generating unit 32 outputs determination model information based on the information stored in the data storage unit 31. The determination model information storage unit 36 stores the determination model information. Then, as further shown in FIG. 1, the aforementioned determination model generating unit 32 includes at least: a virtual environment unit 33 that outputs surface information of a target corresponding to the controlled unit 11 in a virtual space to described later, based on the state information of the controlled unit 11 stored in the data storage unit 31; an information excluding unit 34 that outputs obstacle candidate information obtained by excluding a region not determined as an obstacle (a region where entry is allowed) from the observation data stored in the data storage unit 31; and a first determining unit 35 that outputs a determination of whether the controlled unit 11 approaches or enters an obstacle region (a region other than the region where entry is allowed) and a determined position, based on the surface information output by the virtual environment unit 33 and the obstacle candidate information output by the information exclusion unit 34. The configurations thereof will be described in detail later.

The obstacle detection device 4 is configured with one or a plurality of information processing devices each including an arithmetic logic unit and a memory unit. Then, as shown in FIG. 1, the obstacle detection device 4 includes a second information excluding unit 41 and a second determining unit 42. The functions of the second information excluding unit 41 and the second determining unit 42 can be enabled by execution of a program for enabling the respective functions stored in the memory unit by the arithmetic logic unit.

The second information excluding unit 41 outputs obstacle candidate information obtained by excluding a region not to be determined as an obstacle (a region where entry is allowed) from the current observation data obtained by the observation device 2 (second observation data). The second determining unit 42 determines whether the controlled unit 11 approaches or enters an obstacle (a region other than the region where entry is allowed) based on the current state information on the controlled unit 11 (second state information) and the obstacle candidate information output by the second information excluding unit 41.

Next, mainly, the configurations of the determination model generation device 3 and the obstacle detection device 4 mentioned above will be described in detail.

The state information on the controlled unit 11 stored in the data storage unit 31 of the determination model generation device 3 is, for example, position and posture data of the movable device 1, or position and posture data of each part or a movable part (actuator) of the controlled unit 11. For example, in a case where the movable device 1 is a robot with a movable arm, namely, a multi-joint robot arm, the angle data of each joint constituting the arm is stored as the position and posture data. This angle data can typically be obtained as an electrical signal by a sensor (e.g., a rotary encoder) associated with the actuator driving each joint. Moreover, for example, in a case where the movable device 1 is a hydraulically controlled construction machine such as a backhoe, the position and posture data is acquired by a sensor attached to each movable part or housing of the controlled unit 11. Examples of the sensor include an externally installed sensor such as a tilt sensors, a gyro sensor, an acceleration sensor and an encoder, a hydraulic sensor, and so forth. The installation position and number of sensors can be designed appropriately for each work of the movable device 1 that is the detection target. Moreover, since the controlled unit 11 is caused to be movable by the control by the control unit 12, the position and posture data corresponds to the temporal movement (dynamics or motion) of the controlled unit 11. Specifically, information of an electrical signal as the position and posture data is information obtained in correspondence with the movement of the controlled unit 11 within a certain range of error and delay time. In other words, the movement of the controlled unit 11 can be reproduced using the position and posture data of the controlled unit 11 stored in the data storage unit 31. There are no specific limitations on the temporal frequency (sampling rate) or spatial resolution (accuracy) of the electrical signals, and can be determined as necessary in accordance with the size and feature of the movable device 1, the content of work, and so forth.

Regarding the position and posture data stored in the data storage unit 31 of the determination model generation device 3, the time when the data has been stored may be different from the current time when the movable device 1 is operating. In other words, the state information may be data acquired in the past. Furthermore, if the movable device 1 and a sensor that acquires the position and posture data are equivalent, the state information may be data obtained in other work environments or devices. Moreover, regarding the observation data acquired by the observation device 2 and stored in the data storage unit 31, it is sufficient if it corresponds to the time and location at which the abovementioned position and posture data was acquired, and there are no other limitations on time and location. In other words, since the observation data includes at least part of the housing of the controlled unit 11 as mentioned above, the position and posture data corresponding to the movement of the controlled unit 11 included in that observation data is stored. In other words, the position and posture data of the controlled unit 11 and the observation data obtained by the observation device 2 include temporally identical (synchronized) data within an error range that depends on a certain predetermined temporal frequency (sampling rate).

The virtual environment unit 33 (virtualizing unit) of the determination model generation device 3 sets and constructs a virtual environment in which at least the controlled unit 11 is simulated on a computer. For example, the virtual environment unit 33 constructs a so-called digital twin, which is a virtual environment reproduced by simulation of the dynamics of the controlled unit 11 and the surrounding real environment using a simulator, a mathematical model, and so forth. However, the virtual environment constructed by the virtual environment unit 33 is not limited to a digital twin. Below, two aspects of simulating the controlled unit 11 will be described. The first aspect is the shape of the controlled unit 11. The virtual environment unit 33 sets a model that reproduces the external shape, namely, the size and three-dimensional form of the controlled unit 11, identical to the actual controlled unit 11 or within a certain margin of error, or to scale. This model of the controlled unit 11 can be constructed using a polygon or a set of polygons (i.e., a mesh) based on, for example, the design drawing or CAD (Computer Aided Design) data of the controlled unit 11, the image data of the controlled unit 11, and so forth. Here, in a case where the model of the controlled unit 11 is expressed with a polygon, it will be approximated according to the shape, size, density and other characteristics of the polygon. However, the degree of the approximation can be appropriately determined based on factors such as the size of the controlled unit 11 that is the control target. In the case of expressing the model of the controlled unit 11 with a polygon, the model shows a three-dimensional shape, so that it is not necessary to reproduce the surface material, texture, pattern or the like. The method for constructing the model of the controlled unit 11 is not limited to the aforementioned method. The second aspect is the movability, that is, the movement (dynamics or motion) of the controlled unit 11. The controlled unit 11 includes at least one or more movable parts (actuators) controlled by the control unit 12, and the model of the controlled unit 11 by the virtual environment unit 33 mentioned in the first perspective aspect of simulating the controlled unit 11 is a reproduction of this movable part that is the same as or within a certain margin of error compared to the actual controlled unit 11. The reproduction of movability is sufficient if displacement of position and angle similar to the actual movable part is possible, it is not necessary to reproduce the mechanism or internal structure of the movable part, and there is no limitation on how the movable part is configured. In addition, the virtual environment by the virtual environment unit 33 may include a virtual observation means corresponding to the actual observation device 2, and an observation region that is the target of observation. The virtual observation means will be described later.

Here, the reason and effect of simulating the controlled unit 11 by the virtual environment unit 33 will be described. In the present disclosure, instead of the observation device 2 capturing the actual controlled unit 11 and extracting a region occupied by the controlled unit 11 from the captured information, a model that is different from the actual controlled unit 11 is set by the virtual environment unit 33. One of the reasons for this is to obtain the external shape of the controlled unit 11 without depending on the imaging conditions when imaging the actual controlled unit 11, specifically, the position and posture of the observation device 2, the distance to the controlled unit 11, and the presence or absence of obstructions in between. In the case of depending on the imaging conditions, there is a risk that the external shape of part of the controlled unit 11 may not be acquired due to the field of view range of the observation device 2 and the effect of occlusion. The second reason is that due to a misbehavior or an error in the process of extracting the region occupied by the controlled unit 11 from the captured information, there is a possibility that the external shape of the controlled unit 11 may not be properly obtained. From these points, there is a risk that it is not possible to determine the approach to an obstacle region, that is, this function may not operate properly. Therefore, in the present disclosure, by obtaining the external shape using the model of the controlled unit 11 set by the virtual environment unit 33, it is possible to enable a robust function that does not depend on the imaging conditions at the site or processing accuracy.

FIG. 2 shows a specific configuration example of the virtual environment unit 33 included by the determination model generating unit 32 described above. In FIG. 2, the virtual environment unit 33 includes a controlled unit model 331 (an example of the model of the controlled unit 11) that simulates the actual controlled unit 11 in the real environment, an environment setting unit 332 that sets the controlled unit model 331, and an information generating unit 333 that generates information about the controlled unit model 331.

The environment setting unit 332 performs the placement of a model in which the controlled unit 11 of the actual movable device 1 is simulated (i.e., the setting for position and posture) and the setting for position and posture of a virtual observation device that simulates the actual observation device 2, which will be described later, in the controlled unit model 331 The controlled unit model 331 and the virtual observation device are placed in such a manner as to be the same as a relative position and posture relation between the actual controlled unit 11 and the actual observation device 2, or be reproduced within a certain margin of error or to scale in the three-dimensional space handled by the virtual environment unit 33. That is to say, when one of the controlled unit model 331 and the virtual observation device is a standard for position and posture, the difference in distance and angle with respect to the other is the same as actual, or within a certain margin of error or to scale. It is assumed that the scale herein matches the scale of the controlled unit model 331 with respect to the actual controlled unit 11. Preferably, the virtual environment unit 33 handles a region that includes the movable range of the actual controlled unit 11, and the controlled unit model 331 and the virtual observation device are placed in the same position and posture relation as the actual controlled unit 11. Such a setting of the position and posture relation between the controlled unit model 331 and the observation device 2 is generally referred to as calibration. In other words, the controlled unit model 331 and the virtual observation device are set in a calibrated state. The setting for structures other than the actual controlled unit 11 and boundaries of space such as the ground are not essential. The movable part of the controlled unit model 331 may be set based on the state information of the actual controlled unit 11 stored in the data storage unit 31. Preferably, by the setting of the displacement, angle and so forth to be the same as or within a certain error range of the movable part of the actual control unit 11, the controlled unit model 331 can simulate the movement of the actual controlled unit 11. The movement, that is, the temporal displacement of the movable part of the controlled unit 11, can be reproduced within a certain range of error or delay time by using the position and posture data of the controlled unit 11 stored in the data storage unit 31. Preferably, the controlled unit model 331 within the virtual environment unit 33 can be caused to move in the same manner as the actual controlled unit 11.

The information generating unit 333 generates at least information about the model within the virtual environment unit 33 where the actual controlled unit 11 is simulated. As mentioned above, the controlled unit model 331 reproduces the shape and movement of the actual controlled unit 11 in a virtual environment, so that information corresponding to the shape and movement of the controlled unit 11 is generated by execution of simulation using this model. Specifically, the generated information is either a set of three-dimensional positions occupied by the three-dimensional shape of the model of the controlled unit 11 at certain time within the three-dimensional space handled by the virtual environment unit 33, or time-series values of three-dimensional positions corresponding to the temporal displacement of the model of the controlled unit 11. Preferably, the generated information is a set of position information of the polygons representing the three-dimensional shape of the controlled unit model 331. The spatial resolution of this position information depends on factors such as the size of the polygon representing the control unit model 331. Specifically, the resolution can be changed by performing a process such as interpolating between the position information of the polygons (upsampling) or thinning it out (downsampling). Preferably, the change of the resolution can be executed by, when the processing capability of a computer that processes the information generating unit 333 is high, increasing the spatial resolution, that is, representing with finer polygons or upsampling and, when the processing capability is low, decreasing the resolution, that is, downsampling the position information of the polygons.

As a specific enabling method for the information generating unit 333, a virtual observation means corresponding to the actual observation device 2 can be used. This means enables virtual acquisition of observation data, that is, images and three-dimensional images similar to those obtained by the actual observation device 2, by installation of a model of the observation device in a virtual three-dimensional space corresponding to the position and posture of the actual observation device 2. In other words, the virtual observation means has a function to simulate the observation device 2, and simulate and output observation information observed from the position and posture where the observation device 2 is installed. This virtual observation device may be included in the settings by the aforementioned environment setting unit 332. Since the observation range of the observation device 2 includes at least the movable part of the controlled unit 11, the observation information output by this observation means is information obtained by observing the controlled unit model 331 that simulates the controlled unit 11. In other words, it is possible to obtain the shape of the controlled unit model 331, information of the position and posture in the virtual three-dimensional space, and time-series information corresponding to the movement (dynamics or motion). This virtual observation means can preferably be an observation device with the same performance as that of the observation device 2, that is, with the same imaging range and resolution. The virtual observation means can also be adjusted appropriately according to the processing capacity of the computer processing the information generating unit 333, and other factors.

The information excluding unit 34 (virtualizing unit) excludes a region not to be determined as an obstacle (a region where entry is allowed) from the observation data stored in the data storage unit 31, based on the information generated by the virtual environment unit 33. Specifically, the information excluding unit 34 excludes the three-dimensional shape generated by the controlled unit model 331 or the information generating unit 333 from the observation data (filtering, masking). As mentioned above, this is because when part of the controlled unit 11 is included in the observation data observed by the observation device 2, this region needs to be specified as a region not to be determined as an obstacle. This is because when this exclusion process is not performed, the controlled unit 11 is determined to be in contact with the controlled unit 11 itself at all times. In other words, the information excluding unit 34 outputs information obtained by excluding a region not to be determined as an obstacle and the controlled unit 11 from the observation data. The excluded information refers to regions such as other structures where the controlled unit 11 should not approach or enter in accordance with the environment where the movable device 1 is installed, that is, it is defined as obstacle candidate information (no-entry region information), which includes regions that might pose obstacles to both the obstacle main body and the controlled unit 11. The region excluded by the information excluding unit 34 can include regions other than the controlled unit 11, that is, regions where approach and entry are allowed dependent on work performed by the movable device 1. For example, it is possible by setting the three-dimensional shape of the region to be excluded in the environment setting unit 332 of the virtual environment unit 33 in the same manner as the controlled unit model 331 and generating three-dimensional information corresponding to the region to be excluded by the information generating unit 333, exclude in the same manner as in the case of the controlled unit model 331 (filtering, masking).

A specific enabling method for processing by the information excluding unit 34 includes, for example, a method using images and point cloud data processing, and a method using learning. As an example of the former, there is a method of representing original observation data with three-dimensional information, such as point cloud data, and excluding information of the volume (three-dimensional position) on the three-dimensional space occupied by the controlled unit model 331 in the virtual environment unit 33, from the three-dimensional information. As another example of the former, there is a method of excluding by logic operation such as XOR (Exclusive OR), which is a process of representing the observation data and the three-dimensional information on the exclusion target generated by the information generating unit 333 with regular lattices (voxels) occupied in the three-dimensional space, respectively, and detecting an overlap between the lattices. However, the excluding method is not limited to the above methods. In a case where the controlled unit 11 is moving, as described before, the position and posture data of the controlled unit 11 stored in the data storage unit 31 and the observation data include temporal synchronization information, so that the movement of the controlled unit 11, that is, the movement of the controlled unit model 331 in the virtual environment unit 33 and the observation data have a temporal correspondence relation. Therefore, even when the controlled unit 11 is moving, the information excluding unit 34 can execute the process of excluding the region in synchronization with the movement recorded as the observation data. In a case where the controlled unit 11 is moving, a deviation may occur due to an error that depends on the temporal frequency (sampling rate) of the stored position and posture data and the observation data. That is to say, there is a deviation between the movement of the controlled unit model 331 and the movement recorded as the observation data (delay in either one) in the virtual environment unit 33. In such a case, the information excluding unit 34 excludes a region slightly larger than a region corresponding to the controlled unit 11 and can thereby allow a positional error in the three-dimensional space caused by the temporal deviation. In addition, even when there is a three-dimensional shape error between the actual controlled unit 11 and the controlled unit model 331 in the virtual environment unit 33 or an error between the position and posture of the actual observation device 2 and the position and posture set in the virtual environment unit 33, that is, when there is an error in calibration, it is possible to allow a three-dimensional positional error by excluding a region slightly larger than a region corresponding to the controlled unit 11. In this manner, the region to be excluded can be adjusted as necessary with respect to the original three-dimensional information to be excluded. In particular, it is possible to adjust in accordance with the operation speed of the controlled unit 11 and the resolution of the observation data, but the above adjustment is an example and the adjustment is not limited thereto.

The first determining unit 35 (model generating unit) receives input of obstacle candidate information output by the information excluding unit 34 and information output from the information generating unit 333 in the virtual environment unit 33, and performs an obstacle detection determination process. The obstacle candidate information output by the information excluding unit 34 is information including a region in which the controlled unit 11 should not approach or enter, that is, a region of an obstacle. On the other hand, the shape information output by the information generating unit 333 is information that dynamically represents the controlled unit itself with the shape and movement of the controlled unit 11 reflected. By comparison between these two types of information, the first determining unit 35 can determine whether the controlled unit 11 is approaching or entering (contacting) the obstacle region. For example, the method can be enabled by calculating the distance between three-dimensional position indicated by the obstacle candidate information and a set of positions indicated by the set information of the three-dimensional positions output by the information generating unit 333, and evaluating whether it is less than or equal to a set threshold value (reference information). The set information that is the set of information of the three-dimensional positions can be expressed by, for example, point cloud data, and the distance between the sets can be calculated as, for example, the Euclidean distance between the centers of gravity of the sets, or the Euclidean distance between the nearest points (nearest neighbor points). The method for finding the nearest neighbor points is, for example, using algorithms such as nearest neighbor search and k-neighbor search. However, the method for finding the nearest-neighbor points is not limited to using algorithms such as nearest-neighbor search and k-neighbor search. In addition, this determination can be enabled in the following manner by the reverse processing to the information excluding unit 34 described above. As in the example of the processing by the information excluding unit 34, the set information of the obstacle candidate information and the three-dimensional position output by the information generating unit 333 are expressed by three-dimensional regular lattices (voxels), respectively, and if there are lattices that match between the lattices or between surrounding lattices, it means that there is a position in the three dimensions with a close distance. Therefore, in the determination, for example, a process of seeing an overlap between the lattices at a predetermined resolution (e.g., XOR operation) is performed, and if no overlap is detected, it indicates that the controlled unit 11 is not in proximity to the obstacle region within the range of the distance based on the resolution, and if an overlap is detected, it indicates that the controlled unit 11 is in proximity to the obstacle region. The resolution in this overlap detection, that is, the size of lattice (voxel) depends on the point cloud density (i.e., the size of mesh) of each three-dimensional information, and can be set as necessary in accordance with the processing capability of the first determining unit 35. Preferably, by setting a wide lattice size, the proximity is determined at an early stage, that is, when the distance between the obstacle region and the controlled unit 11 gest close to the set lattice size. On the other hand, by setting a narrow lattice size, spatial resolution, that is, spatial accuracy, for determining the distance between the obstacle region and the controlled unit 11 is improved, so that determination can be made with accuracy even if the obstacle region and the controlled unit 11 have spatially complicated shapes. These determination methods are examples and may be any method as long as it can be determined whether the controlled unit 11 is in proximity to the obstacle region.

The first determining unit 35 further outputs the determined part of the controlled unit 11, that is, the position information in the three-dimensional shape representing the controlled unit 11, when it is determined that it is in proximity to the obstacle region. In practice, a three-dimensional position corresponding to the determined part is identified and output from among the set information of the three-dimensional position output by the information generating unit 333. This process can be enabled in the process of determining the proximity to the obstacle region described above. For example, in the case of a determination method based on the distance between the set of the three-dimensional position indicated by the obstacle candidate information and the set of positions indicated by the set information of the three-dimensional position output by the information generating unit 333, a pair of points of nearest neighbors can be found between both the sets, so that the point output by the information generating unit 333 corresponds to the determined part. Further, in the case of a determination method of representing the obstacle candidate information and the three-dimensional position information output by the information generating unit 333 with three-dimensional regular lattices, respectively, and detecting an overlap between the lattices, the detected lattice represents the determined part in the information output by the information generating unit 333. Here, the three-dimensional position information of the determined part is associated with information that is a reference value (threshold value) for the determination. To be specific, in the former method based on the distance between the sets, the distance at the time of determination is the reference information, and in the latter method based on the overlap of lattices, the lattice size is the reference information. Therefore, preferably, the first determining unit 35 outputs the corresponding reference information in addition to the determined part. The determined part and the reference information are not limited to one point, that is, one place in the three-dimensional shape representing the controlled unit 11. For example, in the former method based on the distance between the sets, a plurality of points within a predetermined range of distance error may be applicable with respect to one determination distance. In addition, it is possible to set a plurality of determination distances and output a plurality of pairs each including the determination distance, that is, reference information, and the determined part at that time. Further, in the latter method based on the overlap of lattices, a plurality of three-dimensional positions output by the information generating unit 333 may be included in the lattice size. Alternatively, a plurality of lattices may be detected as the overlap. Meanwhile, the above outputs are examples, and the outputs are not limited thereto.

As described above, the first determining unit 35, in addition to determination of whether to be in proximity to the obstacle region, outputs a pair of a determined part at the time of the determination and reference information corresponding thereto. Here, in a case where the controlled unit 11 is moving, that is, in a case where there is a temporal change in the position and posture data of the controlled unit 11 stored in the data storage unit 31 used for the determination by the first determining unit 35, the abovementioned determined part and corresponding reference information are associated with the time of the data. The data can be used for a certain finite time width, but it is not limited to a certain signal time width, and data of a plurality of discontinuous time widths can also be used. In the time width of the data used for the determination here, a case where the proximity to the obstacle region does not occur at all and a case where the proximity occurs multiple times can be considered, but the processing by the determination model generating unit 32 uses different data stored in the data storage unit 31 until it occurs at least once. That is to say, the first determining unit 35 outputs at least one pair of a determined part and corresponding reference information. The number of times that proximity to the obstacle region occurs and data to be used are not limited, and determined parts obtained from multiple occurrences and the corresponding reference information are stored as the determination model information described later, respectively.

From the above, the determination model generating unit 32 obtains at least one pair of a determination part and corresponding reference information. Here, information of the determined part is associated with the position and posture data (state information) of the controlled unit 11 stored in the data storage unit 31 as described above. Specifically, by referring to the position and posture data at the time when proximity to the obstacle region is determined from the information on the time, information on the position and posture of the controlled unit 11 at the time of the determination is obtained. Therefore, it is possible to express the relation between the state information of the controlled unit 11 and the determined part. The information representing the relation is defined as determination model information in this example embodiment, and stored in the determination model information storage unit 36. Here, the state information on the controlled unit 11 is past data stored in the data storage unit 31 in the processing by the determination model generating unit 32, but this state information is the same as data acquired with respect to the controlled unit 11 of the movable device 1, and current real-time data can be acquired during the operation of the movable device 1. In other words, the relation between the state information of the controlled unit 11 and the determined part, which is the determination model state information, holds for the movable device 1 in operation. That is to say, it is possible to identify a determined part with respect to the current position and posture data of the controlled unit 11. The determined part, which represents a part in proximity to the obstacle region calculated from the past data, represents a part of the controlled unit 11 that is in proximity to or is easily in proximity to the obstacle region under certain given obstacle candidate information. Therefore, even if the current observation data acquired by the observation device 2, which is different from the past data, is given, it is possible to consider that a part of the controlled unit 11 that is easily in proximity to the obstacle region is identified. This indicates that it is only required to determine the proximity to a specific determined part without determining the proximity to the obstacle region by showing the entire shape of the controlled unit 11 using the virtual environment unit 33 as in the processing in the determination model generating unit 32. The above ideally holds in such a case that the current movement of the controlled unit 11 is similar to that when a determined part is identified by the model generating unit 32, for example, a change in position and posture is within a predetermined range in the three-dimensional space in a predetermined time width. However, the conditions that hold are not limited to the above, and may change in accordance with the size, work environment and content, and operation of the movable device 1. As mentioned above, a plurality of pairs of determination parts and corresponding reference information can be stored in the determination model information storage unit, so that there are methods of applying a plurality of pairs simultaneously or dynamically changing by associating a pair to be applied with the size, work environment and content, and operation of the movable device 1, and the application policy is not limited in this example.

The current state information (second state information) on the controlled unit 11 acquired by the obstacle detection device 4 is, for example, the position and posture data of the movable device 1, and the position and posture data of each part of the controlled unit 11 or the movable part (actuator). That is to say, it is equivalent to the data stored in the data storage unit 31 of the determination model generation device 3 mentioned above. However, the position and posture data acquired by the obstacle detection device 4 corresponds to the current time when the movable device 1 is operating. That is to say, the position and posture data is data corresponding to the temporal movement (dynamics or motion) of the controlled unit 11 at present. In the obstacle detection device 4, it is different in being acquired in real time from the data stored in the data storage unit 31, but is the same in the other points, so that a description thereof will be omitted.

As the observation data acquired by the obstacle detection device 4, preferably, the observation data output by the observation device 2 (second observation information) is acquired. A description of the observation device 2 and the observation data output thereby will be omitted because the data is equivalent to the data stored in the data storage unit 31 of the determination model generation device 3 mentioned above. Further, the installation position of the observation device 2 is not limited, and the observation device may be mounted on the movable device 1, for example. However, in the same manner as the position and posture data on the controlled unit 11 mentioned above, the observation data acquired by the obstacle detection device 4 is data corresponding to the temporal movement (dynamics or motion) of the controlled unit 11 at present. That is to say, the observation data includes the real-time movement of the controlled unit 11.

The second information excluding unit 41 in the obstacle detection device 4 outputs obstacle candidate information obtained by excluding a region not to be determined as an obstacle (entry allowed) from the acquired current observation data. Since this process is the same as that of the information excluding unit 34 in the determination model generating unit 32 mentioned above, except input data is the current observation data observed by the observation device 2, a description thereof will be omitted.

The second determining unit 42 of the obstacle detection device 4 outputs a determination value whether the controlled unit 11 approaches or contacts an obstacle (a region other than the region where entry is allowed), namely, a determination value whether the controlled unit 11 enters a no-entry region, from the current state information on the controlled unit 11 (second state information) and the current obstacle candidate information output by the second information excluding unit 41, based on the determination model information stored in the determination model information storage unit 36. Although the processing by the second determining unit 42 is similar to the processing by the first determining unit 35 in the determination model generating unit 32, it differs in the following points. The first point is that the first determining unit 35 receives input of the surface information of the controlled unit 11 generated by the virtual environment unit 33 using the state information on the controlled unit 11 stored in the data storage unit 31, whereas the second determining unit 42 receives input of a determined part on the controlled unit 11 identified using determination model information stored in the determination model information storage unit 36 and the current state information of the controlled unit 11. The determination model information has a determined part on the controlled unit 11 and reference information corresponding thereto as described above. Here, since the state information of the controlled unit 11 dynamically changes with the operation state of the movable device 1 being reflected, information on the determined part input into the second determining unit 42 may also dynamically change. The second point is that the first determining unit 35 receives input of the obstacle candidate information output by the information excluding unit 34 based on the observation data stored in the data storage unit 31, whereas the second determining unit 42 receives input of the obstacle candidate information output by the second information excluding unit 41 based on the observation data acquired by the observation device 2. That is to say, the second determining unit 42 is different from the first determining unit 35 in that it is based on the information of the determined part on the controlled unit 11 and the observation data at present (real time). As the process of outputting a determination value whether the controlled unit 11 approaches an obstacle (a region other than the region where entry is allowed) based on the determined part and the obstacle information, the same method as the first determining unit 35 can be applied. That is to say, the second determining unit 42 can first identify a determined part to output a distance between the determined part and obstacle candidate information as a determination value, and further, determine whether the distance is less than or equal to reference information to output a final determination value.

The obstacle detection device 4 may notify information on an approach to an obstacle using an indicator or the like, which is not illustrated, based on the determination value output by the second determining unit 42. Further, based on the determination value, a control command output by the control unit 12 of the movable device 1 to the controlled unit 11 may be changed. As the change of the control command, for example, the operation range of the controlled unit 11 is constrained, the operation speed of the controlled unit 11 is limited, or the controlled unit 11 is stopped. By the change of the control command, it is possible to avoid a state where the controlled unit 11 contacts the obstacle. An example of the change of the control command is not limited to the above.

### (Operation)

FIGS. 3A and 3B are flowcharts illustrating an example of a processing procedure performed by the information processing system according to the first example embodiment. First, the processing operation of the information processing system will be described with reference to the flowchart of FIG. 3A.

First, the obstacle detection device 4 checks whether the determination model information is stored in the determination model information storage unit 36 (step S1), and when it is stored (Yes in step S1), proceeds to subsequent processes (from steps S2), and when it is not stored (No in step S1), proceeds to a process of generating the determination model information, which will be described later (step S10).

In a case where the determination model information is stored in the determination model information storage unit 36 (Yes in step S1), the obstacle detection device 4 acquires the current state information on the controlled unit 11 of the movable device 1 (second state information) and the current environmental data of the observation device 2 (second observation information) (step S2).

Next, the second information excluding unit 41 of the obstacle detection device 4 outputs obstacle candidate information obtained by excluding a region not to be determined as an obstacle from the observation data (step S3). The region not to be determined as an obstacle is, as described above, a region corresponding to the controlled unit 11 and a region in which approach or entry is scheduled in work by the movable device 1. The latter scheduled region may be set by the user through an input means or the like, which is not illustrated, or may be stored in a storage means or the like, which is not illustrated. Further, the information may be shared with the information excluding unit 34 of the determination model generation device 3, which will be described later.

Next, the second determining unit 42 of the obstacle detection device 4 outputs a determination value based on the determination model information and the state information of the controlled unit 11, and further, on the obstacle candidate information output by the second information excluding unit 41 (step S4). Here, as the determination value, the second determining unit 42 first identifies a determined part and outputs the distance between the determined part and the obstacle candidate information. An example of the determination model information and an example of the operation of outputting the determination value will be described later.

Next, the obstacle detection device 4 compares the distance, which is the determination value output by the second determining unit 42, with the reference information included in the determination model information stored in the determination model information storage unit 36 (step S5), and when the determination value satisfies the reference information, for example, when the distance is less than or equal to a threshold value that is the reference information (Yes in step S5), outputs an alert of obstacle detection (step S6), otherwise (No in step S5) continues the operation.

Next, with reference to the flowchart of FIG. 3B, a process (step S10 of FIG. 3A) in a case where the determination model information is not stored in the determination model information storage unit 36 (No in step S1 of FIG. 3A) will be described. The determination model generation device 3 starts a process of generating the determination model information shown in FIG. 3B. First, the determination model generating unit 32 acquires the state information on the controlled unit 11 stored in the data storage unit 31 and the environment data (step S11).

Next, the virtual environment unit 33 outputs surface information on the controlled unit 11 based on the state information (step S12). In detail, the virtual environment unit 33 loads the controlled unit model 331 simulating the controlled unit 11. Subsequently, the environment setting unit 332 performs the placement of the controlled unit model 331, that is, the setting of the position and posture, and the setting of the information generating unit 333, that is, the placement of a virtual observation device that simulates the observation device 2 described above. (setting of the position and posture) Information such as the model and the settings in the virtual environment unit 33 may be stored in a storage device or the like, which is not illustrated, of the determination model generation device 3, or may be set by the user operating through an input means or the like, which is not illustrated. Then, under these settings, the information generating unit 333 outputs the surface information on the controlled unit 11.

Next, the information excluding unit 34 outputs obstacle candidate information obtained by excluding a region not to be determined as an obstacle from the observation data (step S13). This processing is equivalent to the processing by the second information excluding unit 41 in the obstacle detection device 4 described above.

Next, the first determining unit 35 outputs a determined part and reference information based on the surface information on the controlled control unit 11 and the obstacle candidate information (step S14). An operation example will be described later together with illustration of the determined part and the reference information.

Then, the determined part and the reference information are then stored in the determination model information storage unit 36 as the determination model information (step S15). The processing by the determination model generation device 3 (steps S11 to S15 of FIG. 3B) and the processing by the obstacle detection device 4 (steps S1 to S6 of FIG. 3A) may be executed independently or in parallel, but as described above, the processing by the determination model generation device 3 (steps S11 to S15 of FIG. 3B) is performed at least before the processing by the obstacle detection device 4 (steps S1 to S6 of FIG. 3A). In addition, a processing device (computer) that performs processing may be independent or the same one, and it can be configured in accordance with the required processing capacity as necessary.

Here, an example of the operation of the first determining unit 35 and the second determining unit 42 will be described together with an example of the determination model information. FIG. 4 shows an example of the operation of a configuration in which the movable device 1 includes a robot arm as the controlled unit 11. FIG. 4(4-1) schematically depicts processing by the first determining unit 35. FIG. 4(4-1) shows surface information of the controlled unit 11, namely, the robot arm output by the information generating unit 333 and obstacle candidate information output by the information excluding unit 34 in the determination model generation device 3. The surface information of the robot arm may dynamically change based on the state information stored in the data storage unit 31, for example, information of the angle of each joint of the robot arm illustrated. The obstacle candidate information is also information stored in the data storage unit 31 and may dynamically change. An example of distances (arrows: dashed lines) between sets of positions indicated by the set information of the three-dimensional positions at this time is illustrated. The first determining unit 35 finds the nearest distance (arrow: solid line) of the distances by an algorithm such as nearest neighbor search. However, since the surface information and the obstacle candidate information are time-varying information (time-series data), the nearest neighbor distance may change with the time. Therefore, the nearest neighbor distance may also be time-varying information.

Next, in FIG. 4(4-2), a determined part and reference information are schematically depicted as determination model information. The determination model generating unit 32 outputs determination model information as illustrated in FIG. 4(4-2) based on the nearest neighbor distance information described above. In the example shown in FIG. 4(4-2), a robot hand (end effector) part at the tip of the robot arm that is the nearest neighbor at the time shown in FIG. 4(4-1) is set as one of the determined parts, and the distance at that time is denoted by “Lth” as a threshold value. Moreover, in FIG. 4(4-2), a line (solid line) connecting the determined part and the state information is a schematic representation of the geometric definition of the position of the determined part, and it is possible to uniquely obtain the position of the determined part by means such as forward kinematics based on the state information. As shown in FIG. 4(4-2), the determined part does not need to be one, and it is possible to determine as necessary from the time-series information of the nearest neighbor distance based on, for example, the determined part and a threshold distance to be set and the upper limit of the number of parts. Further, the distance threshold value “Lth” as the reference information does not need to be a value of an actually calculated nearest neighbor distance. For example, in a case where the time-series information of the nearest neighbor distance includes only long enough information such that there is no risk of collision, it is also possible to set to a short distance at a certain specified rate with respect to the distance. Conversely, in a case where only information with a short distance such that there is a risk of collision is included, it is also possible to set to a long distance at a certain specified rate with respect to the distance. In addition, this reference information may be in a correspondence relation with the determined part, and further, the determined part and the reference information may be in a correspondence relation with the operation, namely, state information of the robot arm, and information indicating those correspondence relations are stored as the determination model information. To be specific, an example can be considered that the tip portion of the robot hand becomes the determined part in the operation of lowering the robot hand and the side portion of the robot hand becomes the determined part in raising or rotating the robot hand.

FIG. 4(4-3) schematically depicts the processing by the second determining unit 42. FIG. 4(4-3) shows the current state information of the robot arm and the obstacle candidate information, as well as the determined parts and reference information as the determination model information. That is to say, the difference from the first determining unit 35 shown in FIG. 4(4-1) is that the surface information of the robot arm is replaced with the determined part. The second determining unit 42 searches for the nearest neighbor distance as in the processing by the first determining unit 35 from the determined part and the obstacle candidate information. However, here, the obstacle candidate information is the set information of three-dimensional positions, but one determined part is the three-dimensional information of one point. That is to say, it is a process of, for one determined part, comparing the distance between one three-dimensional position and the set information of three-dimensional positions. This means that, compared to the fact that the processing by the first determining unit 35 is comparison between the set information of three-dimensional positions, it needs largely reduced computation. In addition, even if there are a plurality of determined parts, the number of determined parts is only doubled. Then, in a case where the nearest neighbor distance is less than or equal to the distance threshold value that is the reference information, a determination that an obstacle is detected is output.

Although an operation example of the first determining unit 35 and the second determining unit 42 and an example of the determination model information are shown above based on FIG. 4, they are examples. Moreover, the calculation of the nearest neighbor, that is, a determined part is not limited to the algorithm illustrated above. For example, as described above, there is a method of calculating by representing the respective set information of three-dimensional positions with three-dimensional regular lattices, and there is no limitation in the present invention.

As described above, the processing by the obstacle detection device 4 (steps S1 to S6 of FIG. 3A) and the processing by the determination model generation device 3 (steps S11 to S15 of FIG. 3B) can be independently performed and, for example, the determination model information may be updated by feeding the result of the processing by the obstacle detection device 4 at present back to the processing by the determination model generation device 3, that is, adding the current information to the data storage unit 31. For example, in a case where a distance threshold value, which is the reference information, is long, the distance to the obstacle candidate is sufficiently long such that there is no risk of contact, and the determination to be an obstacle occurs, the distance threshold value that is the reference information may be changed to be shorter based on the state information and the observation data at that time.

As in the example of FIG. 4, the control system 100 in this example embodiment can cause the controlled unit 11 of the movable device 1 to safely operate without approaching or entering the obstacle region observed by the observation device 2, through the operation flow shown in FIG. 3. Moreover, by outputting, of instructions to the control unit 12 described in the process when an obstacle is determined (step S6 of FIG. 3A), an instruction to slow down or avoid in such a manner as to stop the control unit 11, a decrease in work efficiency due to stoppage can be prevented, and work that balances safety and efficiency can be performed.

The control system 100 according to the first example embodiment has been described above. Here, the advantages of the control system 100 over a control system as a comparison target will be described.

First, a task of an existing control system that is a comparison target will be described. Typically, there are two types of obstacle detection methods. The first one is a method of setting in advance a region to be determined as an obstacle based on observation data, the movable range of the movable device 1, and past performance (for example, a case like a contact, an accident, a risk, etc.) and experience. Since this method is set in advance, it is hard to make an error or an oversight. However, since it is necessary to set the region in advance, it is difficult to set the region in correspondence with a minimum necessary region or a dynamically changing region with respect to a changing environment or obstacle. Therefore, this method may result in setting a larger region than necessary (with a margin) in advance, so that a determination becomes excessive, that is, the movable device 1 frequently stops and slows down, resulting in a decrease in work efficiency. In addition, setting and adjusting a region determined to be an obstacle may lead to an increase in the number of man-hours worked by experts on site, that is, a decrease in work efficiency. The second one is a method of detecting an obstacle based on the observation information and determining it based on the detected position. For example, a method such as object detection by deep learning can be applied, but in general, a detection target object to be learned in advance, so that there is a fear that there is no guarantee that it can reliably detect unknown objects. That is to say, false detection or oversight (detection omission) may occur. From the above, in the comparison target control system, it is difficult to accurately control the controlled unit 11 with work efficiency while detecting an obstacle with high safety and reliability.

Next, regarding a feature of the control system 100 according to the first example embodiment, the following three points will be described. The first point is that a region or object to be determined as an obstacle is not set in advance. That is to say, it is possible to solve the problem in the comparison target method described above without fixed setting and without the hassle of setting. The second point is that a determination process based on object detection is not performed. That is to say, since it is possible to deal with an unknown object and no oversight occurs, the problem in the comparison target method described above can be solved. The above two features are based on the difference in the determination means of the control system 100, in which a region and object determined not to be an obstacle and a region where entry is allowed, that is, a known object with information are excluded from obstacles, while all unknown objects without information are regarded as obstacles. The third point is that the computational load necessary for the obstacle determination process for the current movable device is low. As described above, the processing by the control system 100 can be largely separated into two categories: the generation of the determination model information by the determination model generation device 3 and the obstacle determination process on the current movable device 1, that is, the controlled unit 11 by the obstacle detection device 4. As mentioned above, the latter process is an operation of sets of determined parts and three-dimensional position information indicating isolated positions, that is, an operation in order of the number of sets, so that it is much less computationally expensive than the former process on sets of three-dimensional position information, that is, an operation of the square of the number of sets. Therefore, the obstacle detection device 4 can be operated by a processing device with a low processing capacity and low power consumption. Although a configuration method and an installation location of the obstacle detection device 4 are not limited in the present invention, for example, a small-sized processing device can be mounted on the movable device 1 for the above reasons. In addition, even if the comparison target system is replaced, the low power consumption can extend the operating hours, for example, when there is a limit to the portable movable device 1, that is, the power supply time. In this regard, it is possible to shorten the charging time and battery replacement time, and it has the effect of improving work efficiency.

### Second Example Embodiment

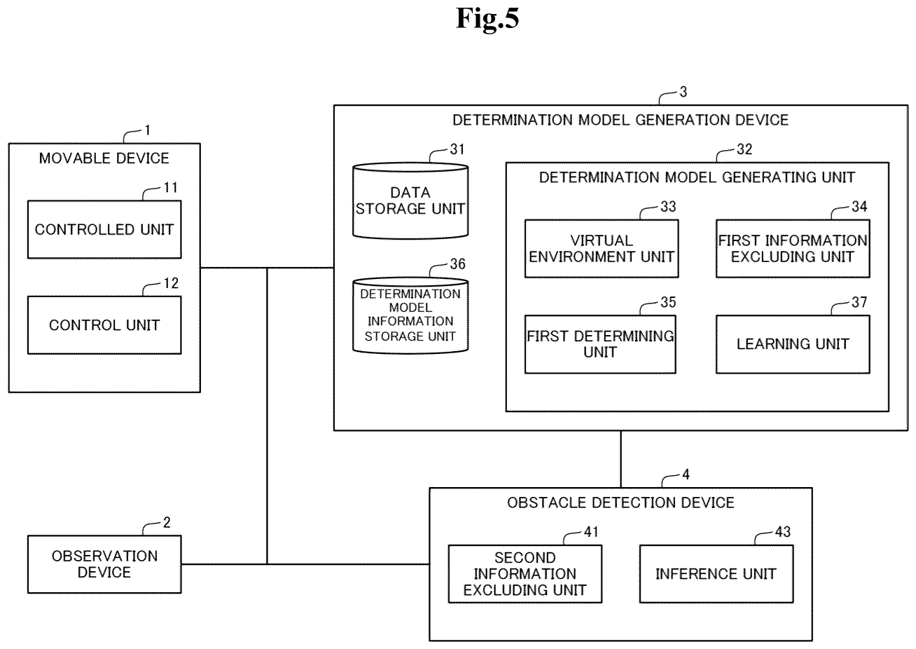

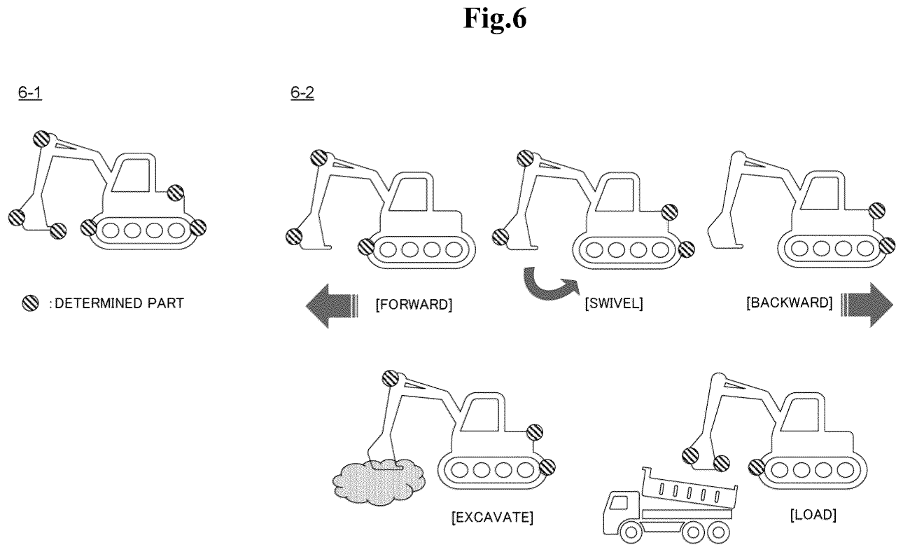

Next, a second example embodiment of the present invention will be described with reference to FIGS. 5 to 6.

### [Configuration]

FIG. 5 is a diagram illustrating an example configuration of an information processing system in this example embodiment. As shown in FIG. 5, the information processing system in this example embodiment is provided with a learning unit 37 instead of the determination model information storage unit 36, compared with the determination model generation device 3 in the information processing system of the first example embodiment shown in FIG. 1. Further, as shown in FIG. 5, the information processing system in this example embodiment is provided with an inference unit 43 instead of the second determining unit 42, compared with the obstacle detection device 4 in the information processing system of the first example embodiment shown in FIG. 1. Since the other components denoted by the same reference numerals and the operation are the same as those of the information processing system according to the first example embodiment, a description thereof will be omitted below.

The information processing system of the second example embodiment is characterized in that information is not stored in a form of explicitly determining the determination of an obstacle, unlike the determined part and the reference information that are the determination model information in the first example embodiment. In other words, information such as the determined part uniquely obtained by the calculation formula by the state information of the controlled unit 11 and the geometric configuration, and the distance threshold value that uniquely determines the size relation (unequal sign) of the nearest neighbor distance are not used. Instead, the determination model generation device 3 includes the learning unit 37, and the obstacle detection device 4 includes the inference unit 43. The learning unit 37 and the inference unit 43 are enabled by execution of a program by the respective arithmetic logic units of the determination model generation device 3 and the obstacle detection device 4. The functions and operation thereof will be described below.

The learning unit 37 in the determination model generation device 3 receives input of at least state information on the controlled unit 11 stored in the data storage unit 31 and obstacle candidate information output by the information excluding unit 34, and learns in such a manner that a determination value whether to approach or enter an obstacle output by the first determining unit 35 becomes output. That is to say, the learning unit learns in such a manner that, from the state information and the obstacle candidate information, an output that minimizes the difference from the determination value output by the first determining unit 35 is generated. In other words, in the perspective of learning, the learning unit 37 learns the output by the first determining unit 35 as correct answer data, that is, acquires a trained inference model. A method for configuring the learning unit 37 and a learning algorithm are not limited, but a method by deep learning can be used, for example. In that case, information such as the configuration parameter of the neural network, the weight indicating the learning result, and the hyper parameter may be stored in a storage device that is not illustrated, and there is no limitation except the information is shared with the inference unit 43 of the obstacle detection device 4 to be described later.

The inference unit 43 of the obstacle detection device 4 receives input of current state information of the controlled unit 11 and obstacle candidate information output by the second information excluding unit 41, and outputs a determination value whether the controlled unit 11 enters an obstacle. At this time, the inference unit 43 makes inference based on the information learned by the learning unit 37 of the determination model generation device 3 mentioned above. Preferably, the result of learning by the learning unit 37, that is, an output equivalent to the processing by the first determining unit 35 can be obtained.

Here, an effect that differs from that of the first example embodiment will be described. As mentioned above, the first example embodiment is based on information in the form of explicitly determining an obstacle, that is, the determination model information. In the second example embodiment, this point is replaced with learning, that is, information in a form of numerically reproducing an output from an input. This point has an effect of reducing the effort required when generating the first determination model information, such as the setting of conditions for determined parts or the adjustment of the reference information, that is, an effect of improving work efficiency. Further, there is no need to explicitly specify the relation with the state information, that is, the relation with the operation content or the state of the controlled unit 11, and this point can also be replaced with learning. Therefore, from these points, it is possible to increase work efficiency by avoiding excessive obstacle determination while maintaining high safety, and on the other hand, it is possible to increase safety by making it easier to determine in the case of operation and state having been dangerous in the past, so that an effect of further increasing the balance between the work efficiency and the safety according to the present invention can be enhanced.

Here, FIG. 6 shows an example of the operation of the learning unit 37 or the inference unit 43 described above in a case where the movable device 1 is a construction machine and the controlled unit 11 is a backhoe in the second example embodiment. For comparison, FIG. 6(6-1) shows an example of the determination model information in the case of applying the first example embodiment, and FIG. 6(6-2) shows an example of learning by the learning unit 37 of the second example embodiment. A determined part shown in FIG. 6(6-1) is a position that is explicitly defined as one of the determination model information. That is to say, it is a position uniquely determined from the state information of the movable part (actuator) of the backhoe and the geometric information. On the other hand, a determined part shown in FIG. 6(6-2) is a position in which a place where obstacle determination is made by the inference unit 43 is visualized as an example using information learned by the learning unit 37. From FIG. 6(6-1), it can be seen that especially the movable part and the outer periphery of the backhoe surface are the determined parts, and in the case of performing the processing by the second determining unit 42 on all the determined parts illustrated, it is required to perform evaluation of the nearest neighbor distance for the number of sets of three-dimensional position information indicated by the obstacle candidate information x the determined parts (six locations in FIG. 6(6-1). On the other hand, FIG. 6(6-2) illustrates that the determined parts differ in accordance with the difference in the state information of the backhoe input into the learning unit 37 or the inference unit 43, that is, the difference in the operation such as “forward”, “swivel”, and “backward” (FIG. 6(6-2), upper column), and the difference in work (task) such as “excavate (soil and sand)” and “load (on a dump)” (FIG. 6(6-2), lower column). Thus, preferably, the surface position of the backhoe that is expected to approach the obstacle candidate information tends to be determined in accordance with the difference in operation and work of the backhoe. That is to say, learning is performed in consideration of the operation content including the operation and work of the movable device 1 as an example of the state information of the movable device 1, and as a result, it is possible to generate a model by which a determined part responsive to movement such as the operation direction corresponding to the operation content can be inferred, and it is possible to set an appropriate determined part more responsive to the state of the movable device 1. Furthermore, learning may be performed in consideration of the obstacle candidate information based on the observation information as an example of work environment information. As a result, it is possible to generate a model by which a determined part responsive to the movement of the movable device 1 in a specific work environment, that is, an environment corresponding to the observation information can be inferred, and it is possible to set a determined part suitable for the work environment. In the determination method, evaluation of the nearest neighbor distance is not performed for each determined part unlike in the first example embodiment of FIG. 6(6-1), and the inference unit 43 makes determination based on the information learned by the learning unit 37, so that an increase of computation amount due to an increase of determined parts can be inhibited. However, since the determined part shown in FIG. 6(6-2) is not information in which the position is defined as described above, it is illustration on the assumption of the determination result by the inference unit 43, and it is not mentioned in the present invention to actually visualize the determined part as shown in FIG. 6(6-2).

In FIG. 6, a difference in the determined part, that is, the position to be determined on the surface of the controlled unit 11, has been described. Another feature of the second example embodiment is a point related to the reference information of the determination model information. In the first example embodiment, as illustrated in FIG. 4, it is required to explicitly set a distance threshold value as the reference information, that is, define the reference information in such a form as to be uniquely determined by a relation such as an inequality sign. On the other hand, in the second example embodiment illustrated in FIG. 6, the learning unit 37 learns including the reference information, it is not necessary to explicitly define the reference information at the time of determination by the inference unit 43. Further, it is possible to use, as the state information of the controlled unit 11, other than information of the angle of the actuator and the position of a specific part, information of the time derivative, that is, information on speed and acceleration at the time of learning by the learning unit 37. Therefore, preferably, in a case where the displacement speed of the specific part of the controlled unit 11 is high, it is possible to increase the certainty (safety) of the determination by learning so as to increase a value corresponding to the distance threshold value of the reference information, that is, determining with a longer distance extension (margin). Conversely, in a case where the displacement speed of the specific part of the controlled unit 11 is low, it is possible to inhibit the decrease in work efficiency due to unnecessary determination by learning so as to decrease a value corresponding to the distance threshold value of the reference information, that is, reducing the distance extension period.

As described above, the information processing system shown in the second example embodiment is characterized in that without the need for explicitly setting the determination model information in the first example embodiment, specifically, the determined part indicating the surface position and the reference information indicating the determination threshold value, based on the state information of the control part 11, the relation is set inductively from past data by learning, that is, modeling is performed. In addition, it is characterized in that the determined part and the determination threshold value may differ in accordance with work (task) and operation state (speed and acceleration), that is, in accordance with the risk in the controlled unit 11, even under the geometric configuration defined for a certain controlled unit 11.

In the learning by the learning unit 37, the configuration, parameters, evaluation function, and the like of a learner thereof (such as a neural network) can be changed or adjusted by the user in any manner through an input means or the like, which is not illustrated. For example, when simulating the result of the first determining unit 35, that is, minimizing the difference from the result, it is possible to provide a bias in the determination to make it easier (or difficult) to make the determination or exclude a specific determination, in response to certain input information. Specifically, there may be means for adjusting the weight of the evaluation function for the difference in accordance with the information input into the learning unit 37. Alternatively, there may be a mechanism to automatically perform the adjustment as described above based on a preset rule, conditional expression, past data, and the like. In other words, the information input into the learning unit 37 is not limited to the obstacle candidate information based on the state information of the control unit 11 and the observation data, which are information stored in the data storage unit 31, and may include information for adjusting the tendency of determination as described above. That is to say, the learning unit 37 can change the information to be learned by increasing the amount of information to be input. Further, the above changes and adjustments may be performed in consideration of (by feedback of) the result of the determination by the inference unit 43. Therefore, with such a mechanism, the learning by the learning unit 37 can be adjusted when, for example, the result of the determination by the inference unit 43 is unfavorable, for example, an oversight of the determination that may cause a safety problem or excessive determination that may have an impact on efficiency occurs.

The configuration and implementation method of the second example embodiment are not limited in the present invention, as in the first example embodiment, but preferably, the processing capacity required for the inference unit 43 is less than that required for the learning unit 37. Therefore, as in the first example embodiment, it is possible to mount the obstacle detection device 4 on the movable device 1 or the like by configuring with a low power consumption processing device. Even if the device of the existing movable device 1 is replaced, the lower power consumption will contribute to increase work efficiency by extending the operating hours of the movable device 1 and reducing the frequency of battery replacement. On the other hand, the determination model generation device 3 equipped with the learning unit 37 may be executed, for example, on a large-scale computer connected by a network (on the cloud). Alternatively, the determination model generation device 3 may be executed on a computer (on an edge, on a press miss, or in an on-pre environment) installed around the movable device 1, such as a control room or a monitoring room for controlling or monitoring the movable device 1. Further, at least the processing by the learning unit 37 may be performed offline, that is, there may be a delay with respect to the timing when data is acquired by the movable device 1 and the observation device 2. On the other hand, it is preferable that at least the processing by the inference unit 43 is performed online, that is, it is preferable to be processed with a sufficiently small delay time (real-time) with respect to the timing when data is acquired by the movable device 1 and the observation device 2.

### Third Example Embodiment

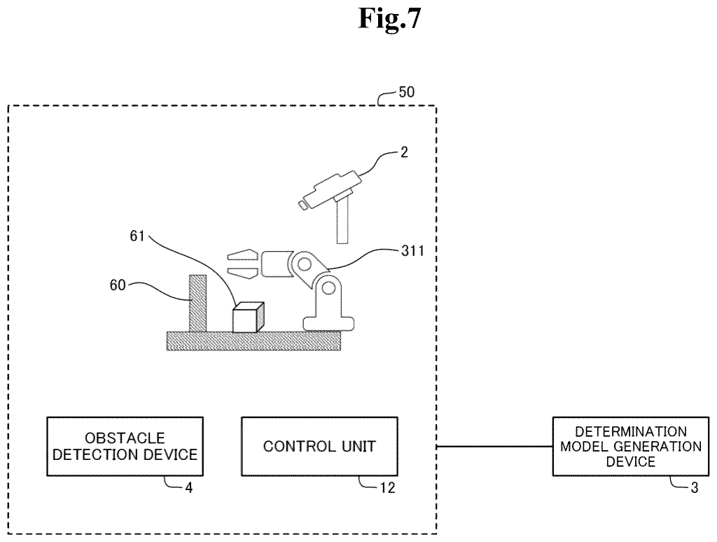

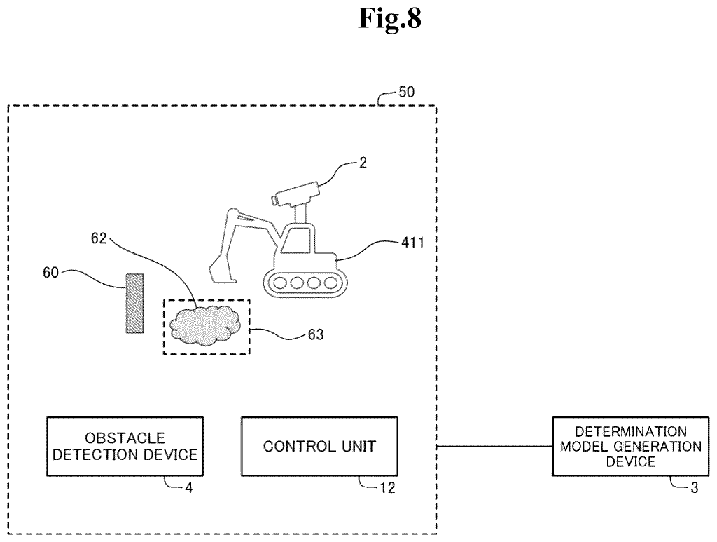

Next, a third example embodiment of the present disclosure will be described with reference to FIGS. 7 to 8. In this example embodiment, an application example based on the above first and second example embodiments will be described.

### Application Example 1

An application example 1 is an example in which the movable device 1 in the first or second example embodiment is an arm-equipped robot, known as an articulated robot arm. FIG. 7 is a view illustrating an example of a configuration of an information processing system in the application example 1.

The application example 1 shows a configuration of an information processing system in a case where the movable device 1 in the first or second example embodiment includes a robot arm 311, the observation device 2 is a device capable of acquiring three-dimensional information such as a depth (depth) camera and LiDAR, and the determination model generation device 3 and the obstacle detection device 4 are those of the first or second example embodiment. FIG. 7 shows a configuration in which one control unit 12 corresponding to the robot arm 311 and one observation device 2 are connected to one corresponding obstacle detection device 4 and one corresponding determination model generation device 3, but the number and configuration of those connected are not limited to the above. For example, a plurality of robot arms 311 or observation devices 2 are included, and in that case, even if each of the robot arms is connected to a plurality of obstacle detection devices 4, one of the obstacle detection devices 4 may process simultaneously, and there is no limitation in the configuration. The robot arm 311 may be configured to be movable by being mounted on a mobile device such as an autonomous transport vehicle (AGV, UGV). In addition, FIG. 7 shows an obstacle region 60 in which the robot arm 311 should not enter and a target object 61 to be subjected to work (task). Hereinafter, the task is, for example, a so-called pick and place of grasping (picking) the target object 61 at one point and placed at another point, but the task is not limited in this application example.

In the application example 1 shown in FIG. 7, the robot arm 311 corresponding to the controlled unit 11 in the first or second example embodiment and the control unit 12 correspond to the movable device 1. Here, the control unit 12 corresponds to a controller that controls the robot arm 311. Further, the robot arm 311, the control unit 12, the observation device 2, and the obstacle detection device 4 are included in a work environment 50. The components within this work environment 50 are connected via communication means (wired or wireless). Preferably, it is within a range of communication speed or delay time that does not interfere with real-time processing in accordance with the operation speed of the robot arm 311 and the control period of the control unit 12. The determination model generation device 3 does not need to be included in the work environment 50. The application example 1 shown in FIG. 7 shows an example of a case where it is located in a physically different place connected with the work environment 50 by the communication means. The communication means connecting the work environment 50 and the determination model generation device 3 may be equivalent to the communication means connecting the components within the work environment 50 described above or may be a communication means with lower communication speed or larger delay, but the communication means is not limited in this application example. Moreover, in a case where the robot arm 311 is configured to be movable, the work environment 50 may be set in accordance with the movement range. This is based on a fact that the configuration and communication means as described above do not need communication corresponding to the current state of the robot arm 311 within the work environment because the determination model generation device 3 uses past data stored in the data storage unit 31 as explained in the first and second embodiments. On the other hand, the obstacle detection device 4 needs a communication speed or a delay time that does not interfere with real-time processing because it outputs an alert or an instruction to the control unit 12 when an obstacle is determined based on the current state information of the robot arm 311 and the observation data of the observation device 2.

The observation device 2 is a device capable of acquiring three-dimensional information such as a depth (depth) camera and LiDAR in the application example 1, as well as the observation device 2 of the first or second example embodiment. Although a position where the observation device 2 is installed is not limited, the target of obstacle detection in this information processing system is within the observation region of the observation device 2. The observation device 2 may be mounted on the robot arm 311, and in a case where the robot arm 311 is mounted on a mobile device such as an autonomous transport vehicle, the observation device 2 may be mounted on the mobile device.

In the following description, as an example of controlling an actual work (task) using the information processing system, a task of the robot arm 311 grasping (picking) the target object 61 will be described. As described above, the observation range of the observation device 2 may include part of the robot arm 311. FIG. 7 shows the obstacle region 60 where the robot arm 311 is not allowed to approach or enter. This obstacle region 60 may be, for example, a structure, another object that is not subjected to the task, or a region that does not have a physical shape and does not allow entry, and further, may be composed of a plurality of regions as shown in FIG. 7. However, the obstacle region 60 shall be defined as a region included in the observation range of the observation device 2. That is to say, in a case where the obstacle region is continuous beyond the observation range, a region defined by the observation range is an obstacle region 53. Further, the target object 61 grasped in this task shall be included in the observation range of the observation device 2. FIG. 7 shows only one target object 61 as an example, but the number and arrangement of target objects are not limited in this application example. In order to cause the robot arm 311 to execute the task of grasping the target object 61, the robot arm 311 needs to approach the target object 61 and eventually grasp, that is, contact the target object 61. As in the robot arm 311 schematically illustrated in FIG. 7, typically, a robot arm has an end effector such as a robot hand, and the end effector contacts and grasps the target object 61. In other words, the robot arm 311 contacts the target object 61, but the target object 61 is not an obstacle and therefore needs to allow approach and contact.

Hereinafter, a method for performing the task of grasping the target object 61 without the robot arm 311 approaching or entering the obstacle region 60, using the determination model generation device 3 and the obstacle detection device 4 described in the first or second example embodiment will be described. In the following, first, a case in which at least one or more of “a case of using the robot arm 311 for the first time”, “a case where the work environment 50 is an environment used for the first time”, and “a case where the content of the task or the target object 61 is used for the first time” hold, and in a case where there is no determination model information in the first example embodiment or no learned information in the second example embodiment will be described. That is to say, it is a case where there is no determination model information (No in step S1) in the flowchart of the first example embodiment shown in FIG. 3A.

The determination model generation device 3 acquires the state information of the respective joints configuring the robot arm 311 and the observation data acquired by the observation device 2, that is, three-dimensional information within the observation range, and stores them into the data storage unit 31. Preferably, it is desired to acquire while moving the robot arm 311 as in the actually executing task, but predetermined (programmed) operation or the like may be performed, for example, and there is no limitation. Moreover, preferably, the observation data acquired by the observation device 2 is desired to include information on the obstacle region 60, but it may be part of the obstacle region 60 or an obstacle as an alternative or an example thereof, for example, and there is no limitation. However, it is assumed that information on the three-dimensional shape of the robot arm 311 and summary information on the target object 61 at the time of executing the task, for example, information such as shape and size, have been obtained.

The virtual environment unit 33 of the determination model generation device 3 constructs a model in which the three-dimensional shape and movability of the robot arm 311 are simulated. By use of the state information of the robot arm 311 stored in the data storage unit 31, the actual robot arm 311 and the model that the robot arm 311 is simulated in the virtual environment unit 33 are in a synchronized state, which is a state that the positions and postures thereof match within a specified margin of error. In addition, the arrangement of the model by the virtual environment unit 33 is a state where it matches within a certain specified margin of error or the posture matches, that is, calibrated with the position and posture relation between the actual robot arm 311 and the observation device 2. Therefore, the positional relation between the model that the robot arm 311 is simulated in the virtual environment unit 33 and the observation data acquired by the observation device 2, for example, the obstacle region 60 matches the positional relation in the real world within a certain specified margin of error. Therefore, even when part of the robot arm 311 is included in the observation data, a position in the three-dimensional space included in the observation data and a position in the three-dimensional space occupied by the model generated by the information generating unit 333 of the virtual environment unit 33 match within a certain specified margin of error.

The information excluding unit 34 of the determination model generation device 3 excludes (filters) a region on the three-dimensional space occupied by the robot arm 311 from the observation data by using, for example, the means described in the first example embodiment in a case where part of the robot arm 311 is included in the observation data. Furthermore, as described above, in order to cause the robot arm 311 to execute the task of grasping the target object 61, when the target object 61 is included in the observation data, the information excluding unit 34 excludes a region on the three-dimensional space occupied by the target object 61 as in the case of the robot arm 311. For example, there is a method of, by causing the environment setting unit 332 of the virtual environment unit 33 to set a three-dimensional region corresponding to the target object 61, that is, a three-dimensional target object model and causing the information generating unit 333 to output three-dimensional information on the region, excluding it from the observation data as in the case of the robot arm 311. Within the virtual environment unit 33, the position of the model corresponding to the target object 61 is determined based on the result of recognizing the position (and posture) of the target object 61 from the observation data. Although a method for recognizing the position of the target object 61 is not limited in the application example 1, autonomous object recognition using point cloud processing or deep learning, or a position specified by the user or another device may be adopted. From the above, information obtained by excluding the robot arm 311 and the target object 61 from the observation data in a range observed by the observation device 2 becomes equivalent to the obstacle candidate information in the first or second example embodiment.

Next, the first determining unit 35 of the determination model generation device 3 receives input of the surface information on the robot arm 311 output by the virtual environment unit 33 and the obstacle candidate information output by the information excluding unit 34. The first determining unit 35 outputs a determination value based on the set information of three-dimensional position information representing at least part of the obstacle region 60 included in the obstacle candidate information and the set information representing the surface of the robot arm 311. Since the method can be, for example, the method described in the first example embodiment can be applied, a description thereof will be omitted. The output of the first determining unit 35 is stored in the determination model information storage unit as the determination model information in a case where the first example embodiment is applied in the application example 1, whereas the processing by the learning unit 37 is executed thereon in a case where the second example embodiment is applied.

Accordingly, in the application example 1, the determination model information or the learned information is generated by the determination model generation device 3. Subsequently, when operating the robot arm 311 to execute the task in the work environment 50, it is possible to execute the obstacle detection device 4. As mentioned above, the processing by this determination model generation device 3 is essential when there are new points in the robot arm 311, the work environment 50, and the task content. However, even if there is at least one or more similar points, whether processing is necessary or whether the generated determination model information or learned information can be used should be determined as appropriate, depending on the specific robot arm operation plan, work environment, and task content.

Next, a description of a situation in which the robot arm 311 is operated to perform a task in the work environment 50 will be described. The obstacle detection device 4 acquires the current state information of the robot arm 311 and the current observation data observed by the observation device 2. The second information excluding unit 41 of the obstacle detection device 4 outputs obstacle candidate information in which a region corresponding to the robot arm 311 and a region of the target object 61 are excluded from the observation data in the same manner as the information excluding unit 34 of the determination model generation device 3 described above. In a case where the first example embodiment is applied, in this situation, in the obstacle detection device 4, the current obstacle candidate information and the current state information of the robot arm 311 are input into the second determining unit 42 based on the information of the determination model information storage unit 36. Moreover, in a case where the second example embodiment is applied, the current obstacle candidate information and the current state information of the robot arm 311 are input into the inference unit 43 based on the learned information obtained by the learning unit 37. Since the subsequent operation is equivalent regardless of which example embodiment being applied, it will be described without distinction.

In the actual work environment 50, the obstacle region 60 depends on the observation range of the observation device 2, and as described above, the observation data stored in the data storage unit 31 of the determination model generation device 3 does not necessarily match the current observation data. That is to say, the current obstacle candidate information, which can change from time to time, includes the obstacle region 60 having not been stored in the data storage unit 31. Even in such a case, the obstacle detection device 4 described in the first or second example embodiment can detect a situation where the robot arm 311 approaches or enters the obstacle region 60 having been observed from time to time. Moreover, even when an obstacle other than the obstacle region 60 appears in the work environment 50, it can be detected. This is because any presetting or information on the obstacle is not assumed, which is one of the features of the first and second example embodiments. Although it is also possible to detect a dynamic, that is, moving obstacle likewise, a processing time from the detection to alert or signal transmission to the control unit 12 is determined in dependence on the speed of a communication means in the work environment 50, the processing speed of the obstacle detection device, and so forth. Therefore, the movement speed of the dynamic obstacle that can be coped with is limited in accordance with the processing time. However, for example, in order to cope with the dynamic obstacle that moves quickly, in the case of the first example embodiment, it is possible to cope with by making the information of the determination distance included in the reference information of the determination model information longer. On the other hand, in the case of the second example embodiment, it is possible to cope with by causing the learning unit 37 to learn the relation between the change rate of the obstacle candidate information and the determination distance.

Next, in the case of approaching the target object 61 to perform the task, first, after the target object 61 is observed by the observation device 2, a recognition means, which is not illustrated, estimates the position of the target object 61, for example, as in the processing by the determination model generation device 3. This means is not limited in the present disclosure. By input of the position information of the target object 61 into the second information excluding unit 41 of the obstacle detection device 4, it is possible to exclude the target object 61 from the current observation data observed by the observation device 2. As a result, when the robot arm 311 approaches the target object 61, it is not determined as an obstacle, and the robot arm 311 can grasp the target object 61 and perform the task.

The application example 1 in a case where the movable device 1 is a robot arm has been described above. According to the application example 1, when the robot arm 311 approaches or enters an obstacle region, by giving an instruction to limit the operation range or operation speed of the robot arm 311 or an instruction to stop, it is possible to enable control that balances work efficiency and safety. Although an example in which the movable device 1 includes the robot arm 311 has been described, it is possible to apply as long as it is a movable device having a movable part such as another robot, machine tool, and assembly machine. In particular, it is suitably applicable to a work machine in which a movable part such as an arm may enter an obstacle region. The shape and number of obstacles and target objects are not limited to those illustrated in FIG. 7.

### Application Example 2

An application example 2 shows an example of a backhoe as a case where the movable device 1 in the first or second example embodiment is a construction machine. FIG. 8 is a view illustrating an example of a configuration of an information processing system according to the application example 2.

The movable device 1 of the application example 2 includes at least a backhoe 411, a control unit 12 that controls the backhoe 411, and the observation device 2 mounted on the backhoe 411 as shown in FIG. 8. The observation device 2 is a device capable of acquiring three-dimensional information such as a depth (depth) camera and LiDAR as in the application example 1, and a configuration mounted on the backhoe 411 is shown as an example, but the type, mounting location and number of devices are not limited. The definition of the work environment 50 and the configurations of the determination model generation device 3 and the obstacle detection device 4 are the same as those of the application example 1. However, within the work environment 50 of the application example 2 shown in FIG. 8, as an example, the obstacle region 60 as in the application example 1 and the target object 62 with an indefinite shape are illustrated. The obstacle region 60 is defined in the same manner as in the application example 1. The target object 62 represents soil and sand in the case of excavating soil and sand as a task performed by the backhoe 411. Therefore, it is difficult to estimate the position of the target object 62 even if the recognition means as in the application example 1 is used. Therefore, in the application example 2, at least a task object of the target object 62, that is, a region to be excavated is defined as a target region 63. The configuration of the information processing system shown in FIG. 8 and the number of connected construction machines and devices are not limited to the above as in the application example 1. For example, it may be configured to include a plurality of backhoes 411.

As in the application example 1, the movable device 1 in the first and second example embodiments is not illustrated, but at least the backhoe 411 and the control unit 12 are included. That is to say, in the application example 2, the backhoe 411 is the controlled unit 11 and the controller 12 that controls the backhoe 411 is the control unit 12. Further, the backhoe 411, the control unit 12, the observation device 2, and the obstacle detection device 4 are included in the work environment 50 in the same manner as in the application example 1. The components within this work environment 50 are connected via communication means (wired or wireless). As described above, the device configuration and connection are basically the same as in the application example 1. However, the backhoe 411 may be automatically (autonomically) operated by the control unit 12, or the operator may be on board and driving (i.e., boarding operation), or the operator may transmit a control signal, which is replacement of the control unit 12, remotely (i.e., remote operation or remote control), and there is no limitation on how to control or operate the backhoe 411. In a case where an obstacle is detected by the obstacle detection device 4 in the application example 2 when the operator is on board and driving the backhoe 411, it may warn the operator using alert or the like, or it may interfere with the operation of the operator by transmitting a deceleration or stoppage signal to the control unit 12.

Since the operation of the determination model generation device 3 and the obstacle detection device 4 in the application example 2 are basically the same as in the application example 1, a description of the common content will be omitted hereinafter.

In the following, as an example of a case of controlling the backhoe 411 for an actual work (task) using the information processing system, a task in which the backhoe 411 excavates soil and sand will be illustrated. The content of this task is an example, and it is not limited to this content. The observation data observed by the observation device 2 shown in FIG. 8 may include part of the backhoe 411. The task assumed in the application example 2 is a task of excavating part of the target object 62 representing soil and sand shown in FIG. 8. Here, in order to excavate part of the target object 62, it is necessary to move part of the backhoe 411, specifically a bucket at the arm tip, close to the target object 62 and eventually making the bucket in contact with the soil and sand. In other words, the backhoe 411 contacts at least part of the target object 62, but the target object 62 is not an obstacle. Therefore, there is a need to allow approach and contact to the target object 62 as well as to the target object 61 in the application example 1. However, as described above, it is difficult to estimate the position of soil and sand at a specific location to be excavated with respect to the target object 62, that is, the soil and sand with infinite form. On the other hand, it is possible to determine the position of a region planned to be excavated using processing means other than the present invention based on three-dimensional information of the target object 62 observed by the observation device 2. That is to say, a position where the bucket of the backhoe 411 contacts for evacuation is known information as described above. Therefore, the target region 63 as shown in FIG. 8 is defined based on the position information of the region planned to be excavated. Here, in the example of FIG. 8, the target region 63 is illustrated as a rectangular region including the region of the target object 62, but it is not limited to the above. Since this target region 63 is excluded from obstacles, that is, allows approach and contact, in order to make it the minimum setting from the aspect of safety, it is favorable to set a volume slightly larger than the dimension of the bucket in consideration of the calibration error and control error of the observation device 2 and the movement of the bucket at the time of excavation, with the volume occupied by the dimension (size) of the bucket of the backhoe 411 centered on the position to be excavated being minimum. However, as shown in FIG. 8, it may be specified as a default volume (or area) regardless of the bucket dimension or the like, and it is not limited in the present invention. Further, in the case of executing a plurality of excavations, it is preferable to set for each excavation from the aspect of safety, but it is possible to set the entire region planned to be excavated for multiple times as the target region 63, which is not limited. Although the target object 62 shown in FIG. 8 is defined as one location, the number thereof may vary in accordance with the work environment and the task content, and is not limited in the present invention.

Hereinafter, as in the application example 1, a method for performing a task of excavating the target object 62 without the backhoe 411 approaching or entering the obstacle region 60 using the obstacle detection device 4 described in the first or second example, in a state where the processing by the determination model information is performed and the determination model information is present in the flowchart shown in FIG. 3A (Yes in step S1) will be described. The obstacle detection device 4 acquires the current state information of each movable part configuring the backhoe 411 and the current three-dimensional information of a region observed by the observation device 2. The position and posture data may be acquired by a sensor attached to each movable part or the housing as a case where the backhoe 411 is hydraulically controlled and current information of each movable part cannot be acquired electrically. The sensor may be, for example, an externally installed sensor such as a tilt sensor, a gyro sensor, an acceleration sensor, and an encoder.

The second information excluding unit 41 of the obstacle detection device 4 outputs obstacle candidate information in which a region corresponding to the backhoe 411 included in observation data similar to the application example 1 and the target region 63 are excluded in the application example 2 are excluded. In this situation, in a case where the first example embodiment is applied, in the obstacle detection device 4, the current obstacle candidate information and the current state information of the backhoe 411 are input into the second determining unit 42 based on the information of the determination model information storage unit 36. Moreover, in a case where the second example embodiment is applied, the current obstacle candidate information and the current state information of the backhoe 411 are input into the inference unit 43 based on the learned information obtained by the learning unit 37. The subsequent operation is preferably equivalent when any of the embodiments is applied and is the same as in the application example 1. That is to say, the obstacle detection device 4 can determine when the backhoe 411 approaches the obstacle region 60, and can execute a task (excavation) on the target region 63 that is the task object without determination.

The application example 2 where the movable device 1 is a construction machine and the controlled unit 11 is the backhoe 411 has been described above. According to the application example 2, when the backhoe 411 approaches or enters the obstacle region, by giving an instruction to limit the operation range and operation speed of the backhoe 411 or an instruction to stop, it is possible to enable control that balances both work efficiency and safety. Although a case where the controlled unit 11 is the backhoe 411 as an example has been shown, but it is possible to apply when it is the movable device 1 having a movable part, such as another construction machine, civil engineering machine, and the like. In particular, the technique described in the application example 2 can favorably be applied to a work machine such that a moving part such as an arm may enter an obstacle region. The shape and number of obstacles is not limited to the above.

### Fourth Example Embodiment

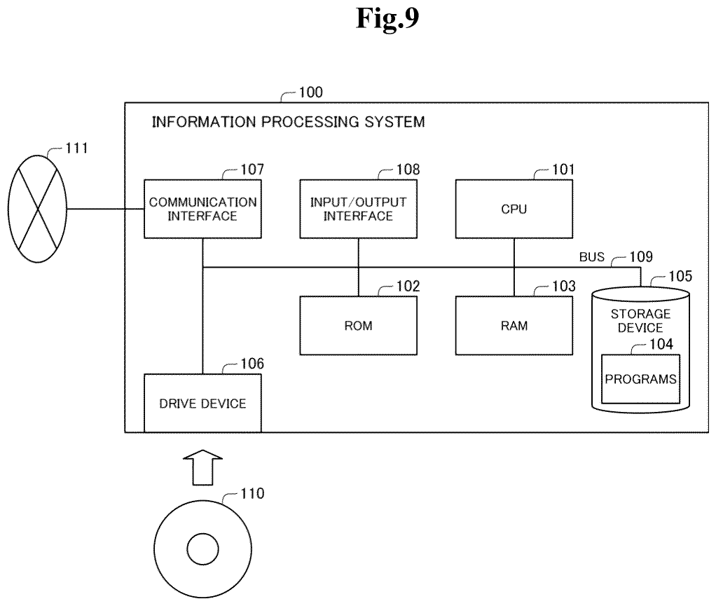

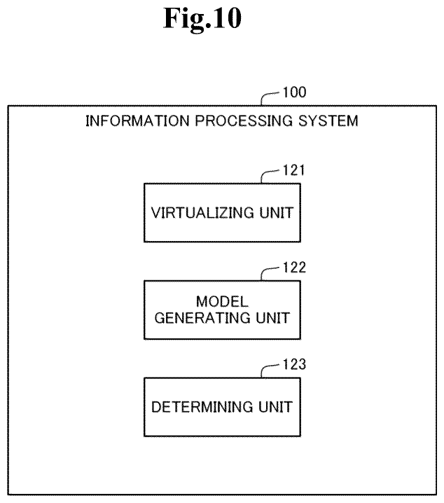

Next, a fourth example embodiment of the present disclosure will be described with reference to FIGS. 9 to 10. FIGS. 9 to 10 are block diagrams showing a configuration of an information processing system in the fourth example embodiment. This example embodiment shows the overview of the configuration of the information processing system described in the above example embodiments.

First, a hardware configuration of an information processing system 100 in this example embodiment will be described with reference to FIG. 9. The information processing system 100 is configured with one or a plurality of information processing apparatuses and, as an example, has the following hardware configuration including:
a CPU (Central Processing Unit) 101 (arithmetic logic unit);
a ROM (Read Only Memory) 102 (memory unit);
a RAM (Random Access Memory) 103 (memory unit);
programs 104 loaded into the RAM 103;
a storage device 105 storing the programs 104;
a drive device 106 that performs reading from and writing into a storage medium 110 external to the information processing apparatus;
a communication interface 107 connected to a communication network 111 external to the information processing apparatus;
an input/output interface 108 that performs input/output of data; and
a bus 109 connecting the components.

FIG. 9 shows an example of the hardware configuration of the information processing apparatus serving as the information processing system 100, and the hardware configuration of the information processing apparatus is not limited to the abovementioned case. For example, the information processing apparatus may be configured with part of the abovementioned configuration, such as not having the drive device 106. Moreover, the information processing apparatus may use a GPU (Graphic Processing Unit), a DSP (Digital Signal Processor), an MPU (Micro Processing Unit), an FPU (Floating point number Processing Unit), a PPU (Physics Processing Unit), a TPU (Tensor Processing Unit), a quantum processor, a microcontroller, or a combination of these, instead of the abovementioned CPU.

Then, the information processing system 100 can construct and include a virtualizing unit 121, a model generating unit 122, and a determining unit 123 shown in FIG. 10 by acquisition and execution of the programs 104 by the CPU 101. The programs 104 are, for example, stored in advance in the storage device 105 or the ROM 102, and are loaded into the RAM 103 and executed by the CPU 101 as necessary. In addition, the programs 104 may be provided to the CPU 101 via the communication network 111, or the programs may be stored in advance in the storage medium 110 and read out by the drive device 106 and provided to the CPU 101. However, the virtualizing unit 121, the model generating unit 122 and the determining unit 123 described above may be constructed using dedicated electronic circuits for enabling such means.

The virtualizing unit 121 sets virtual target information representing a control target having a movable part in a virtual environment based on state information representing a movable situation of the control target, and sets no-entry region information representing a no-entry region of the control target based on observation information obtained by observing a movable space of the control target. At this time, the virtualizing unit 121 sets virtual target information including information of the surface shape of the control target in the virtual environment, for example.

The model generating unit 122 generates a model that identifies a determined part that is a part on which it is determined whether to enter the no-entry region of the control target by using the virtual target information and the no-entry region information. For example, the model generating unit 122 generates a model representing a relation between the state information corresponding to the virtual target information in the virtual environment and the determined part.

The determining unit 123 identifies the determined part of the control target from second state information of the control target by using the model, and determines whether the determined part enters the no-entry region based on the second observation information.

With the configuration as described above, the present disclosure sets virtual target information in the virtual environment from the state information of the control target, so that it is possible to identify a determined part and determine whether to enter a non-entry region without depending on an actual situation of the control target. As a result, it is possible to control the operation of the control target with higher accuracy.

The abovementioned program can be stored using various types of non-transitory computer-readable mediums and provided to a computer. The non-transitory computer-readable medium includes various types of tangible storage mediums. Examples of non-transitory computer-readable medium include magnetic recording medium (e.g., flexible disk, magnetic tape, hard disk drive), magneto-optical recording medium (e.g., magneto-optical disk), read only memory (CD-ROM), CD-R, CD-R/W, semiconductor memory (e.g., mask ROM, programmable ROM, Erasable PROM, flash ROM, random access memory (RAM)). In addition, a program may be provided to a computer by various types of temporary computer-readable medium. Examples of temporary computer-readable medium include electrical signals, optical signals, and electromagnetic waves. The temporary computer-readable medium may provide a program to the computer via a wired communication channel, such as an electric wire and an optical fiber, or a wireless communication channel.

Although the present disclosure has been described above with reference to the above-described example embodiments, the present disclosure is not limited to the embodiments described above. The configuration and details of the present disclosure can be changed in a variety of ways that those skilled in the art can understand within the scope of the present disclosure. In addition, at least one or more functions of the virtualizing unit 121, the model generating unit 122 and the determining unit 123 described above may be executed by an information processing apparatus installed and connected anywhere on the network, that is, may be executed by so-called cloud computing.

### <Supplementary Notes>

The whole or part of the example embodiments disclosed above can be described as the following supplementary notes. Below, the overview of the configurations of an information notification method, an information notification device, and a program will be described. However, the present disclosure is not limited to the following configurations.

### (Supplementary Note 1)

An information processing system comprising:
a virtualizing unit configured to set virtual target information representing a control target having a movable part in a virtual environment based on state information representing a movable situation of the control target, and set no-entry region information representing a no-entry region of the control target based on observation information obtained by observing a movable space of the control target;
a model generating unit configured to generate a model that identifies a determined part using the virtual target information and the no-entry region information, the determined part being a part on which it is determined whether to enter the no-entry region of the control target; and
a determining unit configured to identify the determined part of the control target from second state information of the control target using the model, and determine whether the determined part enters the no-entry region based on the second observation information.

### (Supplementary Note 2)

The information processing system according to Supplementary Note 1, wherein
the model generating unit is configured to generate the model representing a relation between the state information corresponding to the virtual target information and the determined part.

### (Supplementary Note 3)

The information processing system according to Supplementary Note 2, wherein:
the virtualizing unit is configured to set surface information in such a manner as to be included in the virtual target information based on the state information, the surface information representing a surface shape of the control target in the virtual environment; and
the model generating unit is configured to generate the model based on the surface information of the control target and the no-entry region.

### (Supplementary Note 4)

The information processing system according to Supplementary Note 3, wherein:
the virtualizing unit is configured to set, based on the virtual target information, the no-entry region information in which a region obtained by excluding a region where the control target can be movable is the no-entry region; and
the model generating unit is configured to generate the model based on a distance between the control target and the no-entry region based on the surface information of the control target and the no-entry region information.

### (Supplementary Note 5)

The information processing system according to Supplementary Note 3 or 4, wherein
the model generating unit is configured to calculate position information of the determined part that is a part where a distance between the control target and the no-entry region is equal to or less than a preset reference value based on based on the surface information of the control target and the no-entry region information, and generate the model in which the state information corresponding to the surface information and the position information are associated.

### (Supplementary Note 6)

The information processing system according to Supplementary Note 5, wherein
the model generating unit is configured to generate the model in which the position information of the determined part and the reference value used when calculating the position information are associated.

### (Supplementary Note 7)

The information processing system according to Supplementary Note 5 or 6, wherein
the determining unit is configured to identify the position information of the determined part output by input of the second state information into the model, set the no-entry region information based on the second observation information, and determine whether the determined part enters the no-entry region based on the position information and the no-entry region information.

### (Supplementary Note 8)

The information processing system according to Supplementary Note 6, wherein
the determining unit is configured to identify the position information of the determined part output by input of the second state information into the model and the reference value association with the position information, set the no-entry region information based on the second observation information, and determine whether the determined part enters the no-entry region based on the position information and the reference value and on the no-entry region information.

### (Supplementary Note 9)

The information processing system according to any of claims 2 to 8, wherein
the model generating unit is configured to generate the model representing a relation between a content of operation of the control target included in the state information and the determined part.

### (Supplementary Note 10)

The information processing system according to Supplementary Note 9, wherein
the model generating unit is configured to generate the model representing a relation of the content of the operation and the observation information to the determined part.

### (Supplementary Note 11)

An information processing system comprising:
a virtualizing unit configured to set virtual target information representing a control target having a movable part in a virtual environment based on state information representing a movable situation of the control target, and set no-entry region information representing a no-entry region of the control target based on observation information obtained by observing a movable space of the control target; and
a model generating unit configured to generate a model that identifies a determined part using the virtual target information and the no-entry region information, the determined part being a part on which it is determined whether to enter the no-entry region of the control target.

### (Supplementary Note 12)

An information processing method comprising:
setting virtual target information representing a control target having a movable part in a virtual environment based on state information representing a movable situation of the control target, and setting no-entry region information representing a no-entry region of the control target based on observation information obtained by observing a movable space of the control target;
generating a model that identifies a determined part using the virtual target information and the no-entry region information, the determined part being a part on which it is determined whether to enter the no-entry region of the control target; and
identifying the determined part of the control target from second state information of the control target using the model, and determining whether the determined part enters the no-entry region based on the second observation information.

### (Supplementary Note 13)

An information processing method comprising:
setting virtual target information representing a control target having a movable part in a virtual environment based on state information representing a movable situation of the control target, and setting no-entry region information representing a no-entry region of the control target based on observation information obtained by observing a movable space of the control target; and
generating a model that identifies a determined part using the virtual target information and the no-entry region information, the determined part being a part on which it is determined whether to enter the no-entry region of the control target.

### (Supplementary Note 14)

A non-transitory computer-readable storage medium storing a program comprising instructions for causing a computer to execute processes to:
set virtual target information representing a control target having a movable part in a virtual environment based on state information representing a movable situation of the control target, and set no-entry region information representing a no-entry region of the control target based on observation information obtained by observing a movable space of the control target;
generate a model that identifies a determined part using the virtual target information and the no-entry region information, the determined part being a part on which it is determined whether to enter the no-entry region of the control target; and
identify the determined part of the control target from second state information of the control target using the model, and determine whether the determined part enters the no-entry region based on the second observation information.

### (Supplementary Note 15)

A non-transitory computer-readable storage medium storing a program comprising instructions for causing a computer to execute processes to:
set virtual target information representing a control target having a movable part in a virtual environment based on state information representing a movable situation of the control target, and set no-entry region information representing a no-entry region of the control target based on observation information obtained by observing a movable space of the control target; and
generate a model that identifies a determined part using the virtual target information and the no-entry region information, the determined part being a part on which it is determined whether to enter the no-entry region of the control target.

### REFERENCE SIGNS LIST

1 movable device
11 controlled unit
12 control unit
2 observation device
3 determination model generation device
31 data storage unit
32 determination model generating unit
33 virtual environment unit
331 controlled unit model
332 environment setting unit
333 information generating unit
34 information excluding unit
35 first determining unit
36 determination model information storage unit
37 learning unit
4 obstacle detection device
41 second information excluding unit
42 second determining unit
43 inference unit
311 robot arm
411 backhoe
50 work environment
60 obstacle region
61, 62 target object
63 target region
100 information processing system
101 CPU
102 ROM
103 RAM
104 programs
105 storage device
106 drive device
107 communication interface
108 input/output interface
109 bus
110 storage medium
111 communication network
121 virtualizing unit
122 model generating unit
123 determining unit

What is claimed is:

1. An information processing system comprising:
at least one memory storing processing instructions; and
at least one processor configured to execute the processing instructions to:
set virtual target information representing a control target having a movable part in a virtual environment based on state information representing a movable situation of the control target, and set no-entry region information representing a no-entry region of the control target based on observation information obtained by observing a movable space of the control target;
generate a model that identifies a determined part using the virtual target information and the no-entry region information, the determined part being a part on which it is determined whether to enter the no-entry region of the control target; and
identify the determined part of the control target from second state information of the control target using the model, and determine whether the determined part enters the no-entry region based on the second observation information.

2. The information processing system according to claim 1, wherein the at least one processor is configured to execute the processing instructions to
generate the model representing a relation between the state information corresponding to the virtual target information and the determined part.

3. The information processing system according to claim 2, wherein the at least one processor is configured to execute the processing instructions to:
set surface information in such a manner as to be included in the virtual target information based on the state information, the surface information representing a surface shape of the control target in the virtual environment; and
generate the model based on the surface information of the control target and the no-entry region.

4. The information processing system according to claim 3, wherein the at least one processor is configured to execute the processing instructions to:
set, based on the virtual target information, the no-entry region information in which a region obtained by excluding a region where the control target can be movable is the no-entry region; and
generate the model based on a distance between the control target and the no-entry region based on the surface information of the control target and the no-entry region information.

5. The information processing system according to claim 3, wherein the at least one processor is configured to execute the processing instructions to
calculate position information of the determined part that is a part where a distance between the control target and the no-entry region is equal to or less than a preset reference value based on based on the surface information of the control target and the no-entry region information, and generate the model in which the state information corresponding to the surface information and the position information are associated.

6. The information processing system according to claim 5, wherein the at least one processor is configured to execute the processing instructions to
generate the model in which the position information of the determined part and the reference value used when calculating the position information are associated.

7. The information processing system according to claim 5, wherein the at least one processor is configured to execute the processing instructions to
identify the position information of the determined part output by input of the second state information into the model, set the no-entry region information based on the second observation information, and determine whether the determined part enters the no-entry region based on the position information and the no-entry region information.

8. The information processing system according to claim 6, wherein the at least one processor is configured to execute the processing instructions to
identify the position information of the determined part output by input of the second state information into the model and the reference value association with the position information, set the no-entry region information based on the second observation information, and determine whether the determined part enters the no-entry region based on the position information and the reference value and on the no-entry region information.

9. The information processing system according to claim 2, wherein the at least one processor is configured to execute the processing instructions to
generate the model representing a relation between a content of operation of the control target included in the state information and the determined part.

10. The information processing system according to claim 9, wherein the at least one processor is configured to execute the processing instructions to
generate the model representing a relation of the content of the operation and the observation information to the determined part.

11. An information processing system comprising:
at least one memory storing processing instructions; and
at least one processor configured to execute the processing instructions to:
set virtual target information representing a control target having a movable part in a virtual environment based on state information representing a movable situation of the control target, and set no-entry region information representing a no-entry region of the control target based on observation information obtained by observing a movable space of the control target; and
generate a model that identifies a determined part using the virtual target information and the no-entry region information, the determined part being a part on which it is determined whether to enter the no-entry region of the control target.

12. An information processing method comprising:
setting virtual target information representing a control target having a movable part in a virtual environment based on state information representing a movable situation of the control target, and setting no-entry region information representing a no-entry region of the control target based on observation information obtained by observing a movable space of the control target;
generating a model that identifies a determined part using the virtual target information and the no-entry region information, the determined part being a part on which it is determined whether to enter the no-entry region of the control target; and
identifying the determined part of the control target from second state information of the control target using the model, and determining whether the determined part enters the no-entry region based on the second observation information.

13-15. (canceled)

16. The information processing system according to claim 11, wherein the at least one processor is configured to execute the processing instructions to
generate the model representing a relation between the state information corresponding to the virtual target information and the determined part.

17. The information processing system according to claim 16, wherein the at least one processor is configured to execute the processing instructions to:
set surface information in such a manner as to be included in the virtual target information based on the state information, the surface information representing a surface shape of the control target in the virtual environment; and
generate the model based on the surface information of the control target and the no-entry region.

18. The information processing method according to claim 12, comprising
generating the model representing a relation between the state information corresponding to the virtual target information and the determined part.

19. The information processing method according to claim 18, comprising:
setting surface information in such a manner as to be included in the virtual target information based on the state information, the surface information representing a surface shape of the control target in the virtual environment; and
generating the model based on the surface information of the control target and the no-entry region.
